(19) United States
(12) Patent Application Publication
(10) Pub. No.: US 2023/0033949 A1
(43) Pub. Date: Feb. 2, 2023

(54) EYEWEAR WITH SELECTIVE WAVELENGTH FILTERING

(71) Applicant: Oakley, Inc., Foothill Ranch, CA (US)

(72) Inventors: Colin Boyles, Fort Collins, CO (US); Ryan Saylor, Mission Viejo, CA (US)

(21) Appl. No.: 17/842,413

(22) Filed: Jun. 16, 2022

Related U.S. Application Data
(60) Provisional application No. 63/211,303, filed on Jun. 16, 2021.

(51) Int. Cl. G02C 7/10

(52) U.S. Cl. CPC G02C 7/101; G02C 7/108

(57) ABSTRACT

Embodiments comprise an eyewear having a lens, the lens having an optical filter. A transmittance spectral profile of the optical filter comprises a transmission valley having a minimum transmittance with a spectral bandwidth, wherein the minimum transmittance of the transmittance valley is positioned at a first wavelength from about 450 nm to about 475 nm; and the spectral bandwidth, equal to the full width of the transmittance valley at the minimum transmittance plus 30%, is less than or equal to about 30 nm.

### BACKGROUND

Eyewear can include optical elements that attenuate light in one or more wavelength bands. For example, sunglasses typically include a lens that absorbs a significant portion of light in the visible spectrum. A sunglass lens can have a dark coating that strongly absorbs visible light, thereby significantly decreasing the luminous transmittance of the lens. Sunglass lenses, however, are not suitable for all purposes, such as, for example, for indoor use or select sporting activities.

### BRIEF DESCRIPTION OF THE DRAWINGS

Aspects of this disclosure are best understood from the following detailed description when read with the accompanying figures. It is noted that, in accordance with the common practice in the industry, various features are not drawn to scale. In fact, the dimensions of the various features may be arbitrarily increased or reduced for clarity of discussion.

FIG. 1 illustrates a perspective view of an eyewear configured to provide selective light wavelength filtering, according to some embodiments.

FIGS. 2A-2D illustrate cross-sectional views of an optical filter configured to provide selective filtering for an eyewear, according to some embodiments.

FIGS. 3A-14B show optical characteristics of various optical filters of an eyewear, each optical filter configured to provide selective light wavelength filtering and/or chroma enhancement, according to some embodiments.

Illustrative embodiments will now be described with reference to the accompanying drawings. In the drawings, like reference numerals generally indicate identical, functionally similar, and/or structurally similar elements.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over a second feature in the description that follows may include embodiments in which the first and second features are formed in direct contact, and may also include embodiments in which additional features may be formed between the first and second features, such that the first and second features may not be in direct contact. As used herein, the formation of a first feature on a second feature means the first feature is formed in direct contact with the second feature. In addition, the present disclosure may repeat reference numerals and/or letters in the various examples. This repetition does not in itself dictate a relationship between the various embodiments and/or configurations discussed.

Spatially relative terms, such as “beneath,” “underlying,” “underneath,” “below,” “lower,” “above,” “over,” “upper,” “lower,” and the like may be used herein for ease of description to describe one element or feature's relationship to another element(s) or feature(s) as illustrated in the figures. The spatially relative terms are intended to encompass different orientations of the device in use or operation in addition to the orientation depicted in the figures. The device may be otherwise oriented (rotated 90 degrees or at other orientations) and the spatially relative descriptors used herein may likewise be interpreted accordingly.

It is noted that references in the specification to “one embodiment,” “an embodiment,” “an example embodiment,” “exemplary,” etc., indicate that the embodiment described may include a particular feature, structure, or characteristic, but every embodiment may not necessarily include the particular feature, structure, or characteristic. Moreover, such phrases do not necessarily refer to the same embodiment. Further, when a particular feature, structure or characteristic is described in connection with an embodiment, it would be within the knowledge of one skilled in the art to effect such feature, structure or characteristic in connection with other embodiments whether or not explicitly described.

It is to be understood that the phraseology or terminology herein is for the purpose of description and not of limitation, such that the terminology or phraseology of the present specification is to be interpreted by those skilled in relevant art(s) in light of the teachings herein.

In some embodiments, the terms “about” and “substantially” can indicate a value of a given quantity that varies within 5% of the value (e.g., ±1%, ±2%, ±3%, ±4%, or ±5% of the value).

As used herein, the term “between a first value and a second value,” as used for example in “a wavelength range is between 440 nm and 520 nm,” means that the wavelength range is from 440 nm to 520 nm, where end points of 440 nm and 520 nm are both included in the wavelength range.

As used herein, the term “visible spectral range” refers to a wavelength range from about 380 nm to about 780 nm.

As used herein, the term “across a spectral range” refers to all wavelengths (e.g., with an increment of 1 nm) within the spectral range, including the endpoints of the spectral range.

As used herein, the terms “over a spectral range” and “in a spectral range” refer to at least one wavelength within the spectral range.

As used herein, the term “optical transmittance” refers to the fraction of incident electromagnetic power transmitted through an object.

As used herein, the term “visible light transmittance (VLT)” refers to a luminous transmittance profile, such as using Commission Internationale de l′Elcairage (CIE) standard illuminant D65, ISO 12311, or ANSI Z80.3.

As used herein, the term “blue light transmittance” refers to the blue light transmittance as defined in ANSI Z80.3-2018.

As used herein, the term “chroma enhancement filter” refers to a chroma enhancement material, a chroma enhancement dye, a chroma enhancement doping, a chroma enhancement coating, a chroma enhancement film, a chroma enhancement layer, a chroma enhancement wafer, or a chroma enhancement lens body that can provide chroma enhancement to increase the vividness of the perceived colors.

As used herein, the term “selective light wavelength filter” or “light wavelength filter” refers to a light wavelength filtering material, a light wavelength filtering dye, a light wavelength filtering doping, a light wavelength filtering coating, a light wavelength filtering film, a light wavelength filtering layer, a light wavelength filtering wafer, or a light wavelength filtering lens body that can provide light wavelength filtering that selectively blocks light in a desired range.

As used herein, the term “horizontal” refers to a direction along (i.e., in the plane) or substantially parallel to a surface of an eyewear's lens.

As used herein, the term “vertical” refers to a direction substantially perpendicular to the horizontal direction (i.e., perpendicular to the plane defined by an eyewear's lens's surface).

As used herein, the term “disposed,” as used for example in “a first layer is disposed over a second layer,” means that the first layer is either directly placed against the second layer's surface, or that the first layer is indirectly placed over the second layer's surface with at least a third layer in between.

As used herein, the term “coupled,” as used for example in “a first layer is coupled to a second layer” means that the first layer is disposed over the second layer (as “disposed” is defined above), or that the first layer is integrated into the second layer.

Objects that humans can visually observe in the environment typically emit, reflect, or transmit visible light from one or more surfaces. The surfaces can be considered an array of points that the human eye is unable to resolve any more finely. Each point on a surface typically does not emit, reflect, or transmit a single wavelength of light; rather, it emits, reflects, or transmits a broad spectrum of wavelengths that are interpreted as a single color in human vision. Generally speaking, if one were to observe the corresponding “single wavelength” of light for that interpreted color (for example, a visual stimulus having a very narrow spectral bandwidth, such as 1 nm), it would appear extremely vivid when compared to a color interpreted from a broad spectrum of observed wavelengths.

Electronic devices emit electromagnetic radiation that includes visible light (i.e., 380-780 nm). Certain wavelengths emitted from the electronic devices in the visible light spectrum can cause damage to the eye. Organic light emitting diodes (OLED) devices may emit electromagnetic radiation in the visible spectral range. An emission profile of an OLED device may include one or more emission peaks. For example, the emission profile of an OLED device may include an emission peak at about 460 nm.

In some embodiments, the eyewear can include a lens that minimizes transmission of undesirable wavelengths. In some embodiments, the lens minimizes transmission of wavelengths associated with OLED devices. In some embodiments, the wavelengths can include a wavelength corresponding to a peak light emission from OLED devices such as OLED based displays. A benefit of embodiments of the present disclosure is to effectively provide an eyewear having selective light wavelength filtering and chroma enhancement, thus suitable for use when using OLED devices.

The lens includes an optical filter having selective light wavelength filtering properties (i.e., a selective filter). In some embodiments, the lens includes a lens body and a selective light wavelength filter. In some embodiments, the selective filter can be bodily incorporated into the lens body. In some embodiments, the lens can include a chroma enhancement filter. The chroma enhancement filter may be incorporated with the selective light wavelength filter. For example, the chroma enhancement filter may be bodily incorporated into the lens body. In some embodiments, the lens can include an anti-reflection layer disposed over the lens body's rear surface. In some embodiments, the anti-reflection layer can be a coating or a film configured to reduce an optical reflectivity from the lens body's rear surface.

Embodiments of the present disclosure are directed to an eyewear that provides selective light wavelength filtering and chroma enhancement in one or more wavelength bands, and a method of forming the same.

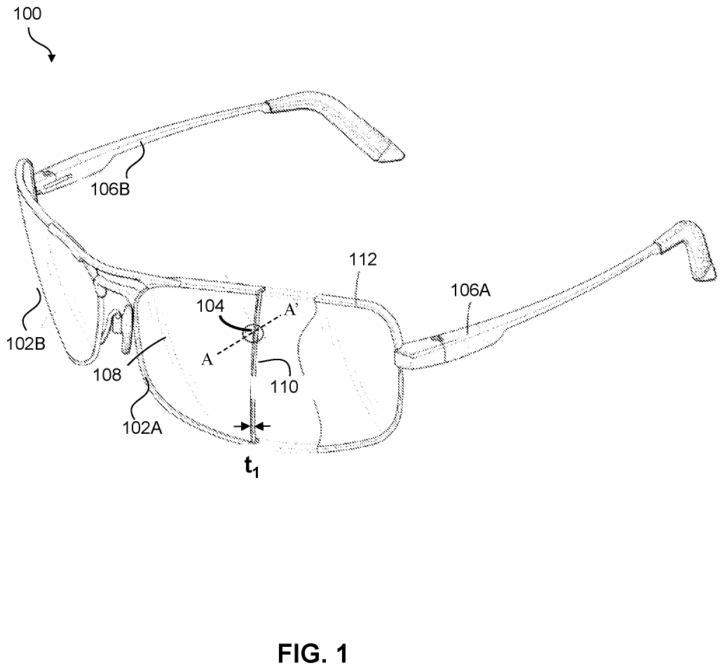

FIG. 1 illustrates a perspective view of an eyewear 100 configured to provide a selective light wavelength filtering, according to some embodiments. Eyewear 100 can include a lens 102A, a lens 102B, a mounting frame 112 configured to support the lenses 102A and 102B, and ear stems 106A and 106B attached to mounting frame 112. Eyewear 100 can be of any type, including general-purpose eyewear, special-purpose eyewear, sunglasses, driving glasses, sporting glasses, goggles, indoor eyewear, outdoor eyewear, eyewear incorporated into headgear (such as visors for helmets), vision-correcting eyewear, contrast-enhancing eyewear, chroma-enhancing eyewear, color-enhancing eyewear, color-altering eyewear, gaming eyewear, eyewear designed for another purpose, or eyewear designed for a combination of purposes. In some embodiments, lenses and frames of many other shapes and configurations may be used for eyewear 100. For example, eyewear 100 can have a single lens, such as in a goggle or visor. It should be noted that eyewear 100 shown in FIG. 1 is not drawn to scale but is drawn to more easily illustrate certain aspects of eyewear 100.

Lenses 102A and 102B have an optical filter that decreases the transmission of undesirable wavelengths. In some embodiments, the optical filter decreases the transmission in a range from about 450 nm to about 475 nm, from about 450 nm to about 470 nm, from about 455 nm to about 470 nm, from about 455 nm to about 465 nm, or at about 460 nm. In some embodiments, the optical filter may also provide chroma-enhancing properties. Lenses 102A and 102B can be non-corrective or corrective for vision. In some embodiments, lenses 102A and 102B can be configured to provide vision correction for a wearer of eyewear 100, and can have optical power. Such lenses can be configured to correct for near-sighted or far-sighted vision or astigmatism. In other embodiments, lenses 102A and 102B are non-corrective or plano lenses that lack such optical power for vision correction.

Lenses 102A and 102B can include an optical filter 104. Each lens 102A and 102B has a front surface 108 and a rear surface 110. In some embodiments, front surface 108 and/or rear surface 110 can be a hydrophobic surface. Optical filter 104 can be configured to provide any desired lens chromaticity, a chroma-enhancing effect, a photochromic effect, an electrochromic effect, an optical polarizing effect, or any combination thereof. In some embodiments, lenses 102A and 102B can be configured to provide a substantially neutral visible light spectral profile as seen through lenses 102A and 102B. For example, an overall color appearance of lenses 102A and 102B can be substantially color neutral and substantially transparent. In some embodiments, the overall color appearance of lenses 102A and 102B has a yellowness index YI E313 less than about 35, less than about 32, less than about 30, less than about 28, less than about 26, or less than about 24.

Lenses 102A and 102B can be made of any of a variety of optical materials including glasses or plastics such as acrylics or polycarbonates. The lenses can have various shapes. For example, each of lenses 102A and 102B can be flat, have one axis of curvature, two axes of curvature, or more than two axes of curvature. Each of lenses 102A and 102B can be cylindrical, parabolic, spherical, toroidal, flat, or elliptical, or any other shape such as a meniscus or catenoid. In some embodiments, each of lenses 102A and 102B can have a blank diameter ranging from about 75 mm to about 90 mm. When worn, lenses 102A and 102B can extend across the wearer's normal straight ahead line of sight, and can extend substantially across the wearer's peripheral zones of vision. As used herein, the wearer's normal line of sight shall refer to a line projecting straight ahead of the wearer's eye, with substantially no angular deviation in either the vertical or horizontal planes. In some embodiments, lenses 102A and 102B can extend across a portion of the wearer's normal straight ahead line of sight. Providing curvature in the lenses 102A and 102B can result in various advantageous optical qualities for the wearer, including reducing the prismatic shift of light rays passing through the lenses 102A and 102B, and providing an optical correction, such as correcting an optical distortion or modifying an optical focal power. Regardless of the particular vertical or horizontal curvature of front surface 108 and rear surface 110 of each of lens 102A and 102B, however, other types of front surface 108 and rear surface 110 of each of lens 102A and 102B may be chosen such as to minimize one or more of power, prism, and astigmatism of lens 102A and 102B in the mounted and as-worn orientation. In some embodiments, each of lenses 102A and 102B can be a plano lens configured to provide the optical correction. In some embodiments, lenses 102A and 102B can be a lens blank or semi-finished so that lenses 102A and 102B can be capable of being machined, at some time following manufacture, to provide the optical correction for the wearer. In some embodiments, lenses 102A and 102B can have optical power and can be prescription lenses configured to correct for near-sighted or far-sighted vision. In some embodiments, lenses 102A and 102B can have cylindrical characteristics to correct for astigmatism. In some embodiments, lenses 102A and 102B can be canted and mounted in a position rotated laterally relative to centrally oriented dual lens mountings.

Each of lenses 102A and 102B can have a thickness ti between front surface 108 and rear surface 110. In some embodiments, thickness ti can be varied along front surface 108 and/or rear surface 110. For example, thickness ti can be varied along a horizontal direction between ear stems 106A and 106B. Thickness ti can also be varied along a vertical direction perpendicular to the horizontal direction and along front surface 108/rear surface 110. In some embodiments, thickness ti can be a tapering thickness along a horizontal axis and can be decentered for the optical correction. In some embodiments, thickness ti can be configured to provide the optical correction for lenses 102A and 102B.

Mounting frame 112 can include orbitals that partially or completely surround the lenses 102A and 102B. Mounting frame 112 can be made of a variety of suitable materials including, for example and without limitation, metal, acetate, nylon, etc. Mounting frame 112 can be of varying configurations and designs, and the illustrated embodiment shown in FIG. 1 is provided for exemplary purposes only. As illustrated, mounting frame 112 can include a top frame portion and a pair of ear stems 106A and 106B connected to opposing ends of the top frame portion. Ear stems 106A and 106B can be configured to support the eyewear 100 when worn by a user. In some embodiments, eyewear 100 can include a flexible band (not shown in FIG. 1) used to secure eyewear 100 in front of the wearer's eyes in place of ear stems 106A and 106B. Further, lenses 102A and 102B may be mounted to the frame 112 with an upper edge of lens 102A and/or 102B extending along or within a lens groove and being secured to mounting frame 104. For example, the upper edge of lens 102A and/or or 102B can be formed in a pattern, such as a jagged or non-linear edge, and apertures or other shapes around which mounting frame 104 can be injection molded or fastened to secure lens 102A and/or 102B. Further, lenses 102A and 102B can be attachable to mounting frame 104 by means of a slot with inter-fitting projections or other attachment structure formed in lenses 102A and 102B and/or mounting frame 104. It is also contemplated that lenses 102A and 102B can be secured along a lower edge of mounting frame 112. Various other configurations can also be utilized. Such configurations can include direct attachments of ear stems 106A and 106B or a strap to lenses 102A and 102B without any frame, or other configurations that can reduce the overall weight, size, or profile of the eyeglasses. In some embodiments, mounting frame 112 can be configured to retain a unitary lens placed in front of both of the wearer's eyes. In some embodiments, the lens may be a standalone unitary lens that directly attach to ear stems 106A and 106B or to a strap.

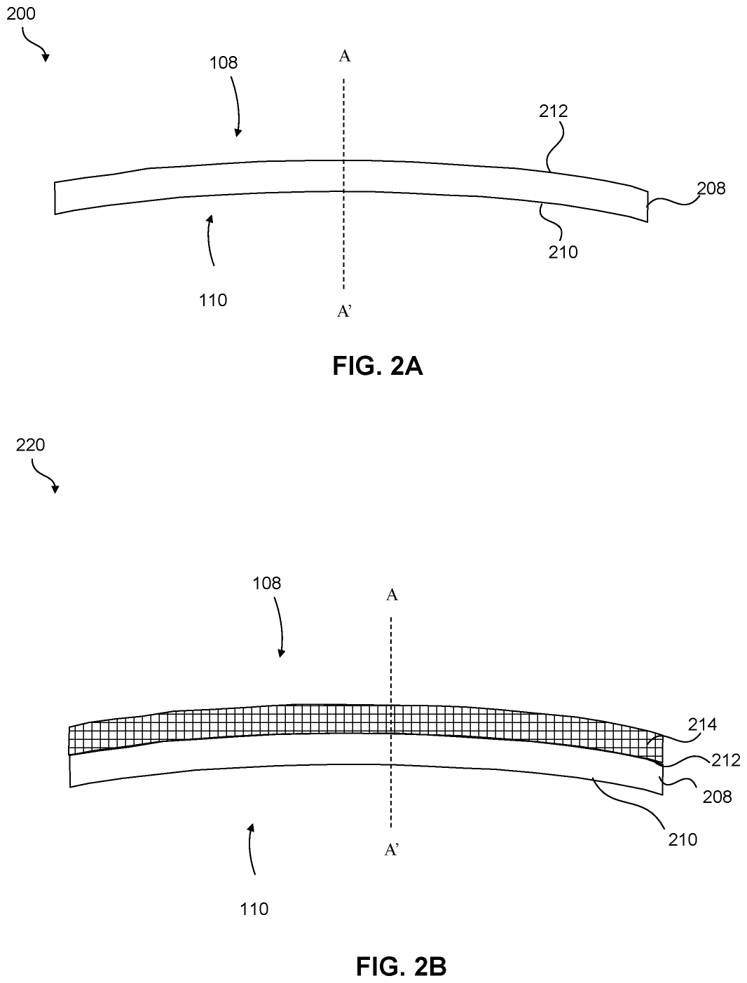

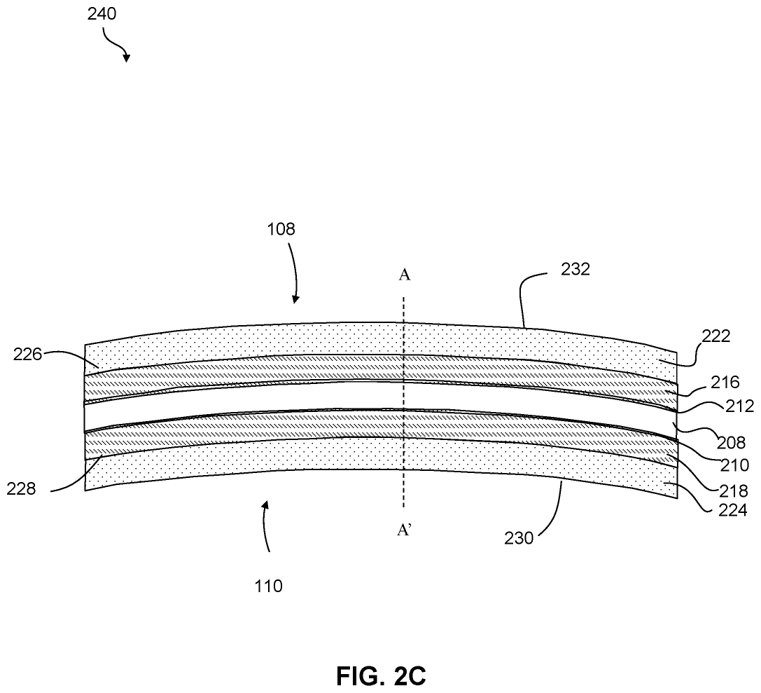

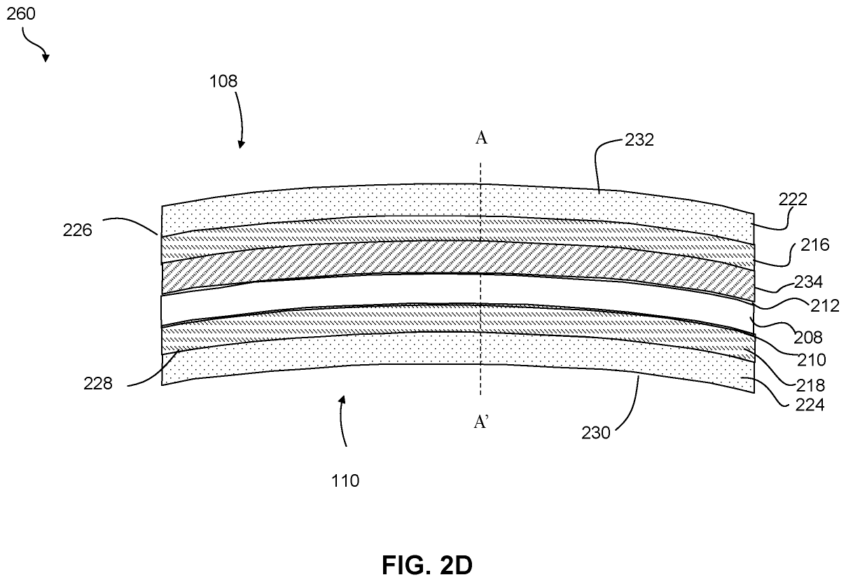

FIG. 2A shows a cross-sectional view of a lens 200, according to some embodiments. Lens 200 can be an embodiment of lenses 102A and 102B shown in FIG. 1. The discussion of lenses 102A and 102B applies to lens 200, unless mentioned otherwise. Further, the discussion of elements with the same annotations in FIGS. 1 and 2A applies to each other, unless mentioned otherwise. Section line A-A′ is shown in both FIG. 1 and FIG. 2A to illustrate the relative orientation of lens 200 between the two figures. As shown in FIG. 2A, lens 200 can have front surface 108 and rear surface 110, can include a lens body 208 having a front surface 212 and a rear surface 210. In some embodiments, front surface 212 and rear surface 210 can respectively represent lens 200's front surface and rear surface.

Lens body 208 can include optical filter 104. For example, optical filter 104 can be integrated with lens body 208. Optical filter 104 can be configured to filter undesired wavelengths. In some embodiments, optical filter 104 can minimize optical transmittance in a range from about 450 nm to about 475 nm, from about 455 nm to about 470 nm, from about 455 nm to about 465 nm, or at about 460 nm.

Lens body 208 can be formed of polycarbonate (PC), allyl diglycol carbonate monomer (being sold under the brand name CR-39®), a resin layer (e.g., MR-8®), glass, nylon, polyurethane, polyethylene, polyamide (PA), polyethylene terephthalate (PET), biaxially-oriented polyethylene terephthalate polyester film (BoPET, with one such polyester film sold under the brand name MYLAR®), acrylic (polymethyl methacrylate or PMMA), triacetate cellulose (TAC), a polymeric material, a co-polymer, a doped material, any other suitable material, or any combination of materials. In some embodiments, lens body 208 can be an injection molded, polymeric lens body.

Lens body 208 can have a concave surface and a convex surface. Lens body 208 can have a desired base curve and thickness (e.g., thickness ti shown in FIG. 1) to provide the optical correction. For example, each of lens body 208's front surface 212 and rear surface 210 can have a spheric, toric, cylindrical, or freeform geometry with proper thickness distribution (e.g., tapering thickness along front surface 212 and/or rear surface 210). Front surface 212 and/or rear surface 210 can have spheric, toric, or cylindrical geometries with a non-zero base curve in a horizontal and/or vertical direction. In some embodiments, front surface 212 and/or rear surface 210 can have spheric, toric, or cylindrical geometries with a base curve of about base 4 and greater, about base 6 and greater, or about base 8 and greater.

In some embodiments, lens body 208 can further integrate with one or more chroma enhancement filters configured to increase a scene's vividness viewed through eyewear 100. For example, the chroma enhancement filters can be dispersed throughout lens body 208. In some embodiments, the chroma enhancement filter can be at least partially incorporated into lens body 208. In some embodiments, lens body 208 can be impregnated with, loaded with, or otherwise include the chroma enhancement filters. The vividness of interpreted colors can be correlated with an attribute known as a chroma value of a color. The chroma value can be one of the attributes or coordinates of the CIE L*C*h* color space. Together with attributes known as hue and lightness, the chroma value can be used to define colors perceivable in human vision. It has been determined that visual acuity can be positively correlated with the chroma values of colors in an image. In other words, the visual acuity of an observer can be greater when viewing a scene with high chroma value colors than when viewing the same scene with lower chroma value colors. Therefore, lens body 208 can be configured to enhance the chroma profile of a scene viewed through lens 200. In some embodiments, lens body 208 having chroma enhancement properties can be a molded body. In some embodiments, the chroma enhancement filter can be provided as a layer enclosed by or intermixed with lens body 208. In some embodiments, lens body 208 having chroma enhancement properties can be configured to increase or decrease the chroma value in one or more chroma enhancement windows in the visible spectral range. The chroma enhancement filter(s) integrated with lens body 208 can be further configured to preferentially transmit or attenuate light in the one or more chroma enhancement windows to provide enhanced chroma values. For example, an environment can predominantly reflect or emit a color, where the chroma enhancement filter integrated with lens body 208 can be adapted to provide the chroma enhancement by attenuating or enhancing an optical transmittance for one or more wavelengths associated with the predominantly reflected or emitted color.

In some embodiments, the chroma enhancement filter and the selective light wavelength filter integrated with lens body 208 can include a dye, such as an organic dye, an Exciton ABS 454, ABS 454F, ABS 455, ABS 456, ABS 574, or ABS 584 dye. Examples of the chroma enhancement filters are disclosed in U.S. Pat. Pub. No. 2016/0070119, entitled “Eyewear with Chroma Enhancement,” filed Sep. 11, 2015, which is incorporated by reference herein in its entirety so as to form part of this specification.

In some embodiments, lens 200 can further include one or more functional layers (not shown in FIG. 2A), such as an optical filter configured to provide optical filtering, a polarizer configured to provide polarization, an electro-chromic layer configured to provide electrochromism, a reflection layer configured to provide a partial reflection of incoming visible light, an absorption layer configured to provide a partial or complete absorption of infrared light, a color enhancement layer, a color alteration layer, an anti-static functional layer, an anti-fog functional layer, a scratch resistance layer, a mechanical durability layer, a hydrophobic functional layer, a reflective functional layer, a darkening functional layer, an aesthetic functional layer including tinting, a glue layer, a mechanical protection layer configured to provide mechanical protection to lenses 102A and 102B, to reduce stresses within lens 200, or to improve bonding or adhesion among the layers in lens 200, a physical vapor deposition (PVD) layer, or any combination of these. In some embodiments, the chroma enhancement filter can be at least partially incorporated into the one or more functional layers in lens 200. In some embodiments, the one or more functional layers in lens 200 can be impregnated with, loaded with, or otherwise include the chroma enhancement filters.

In some embodiments, the lens can include an ultraviolet (UV) absorption layer in the optical filter or a layer that includes UV absorption outside of the optical filter layer. Such a layer can decrease bleaching of the optical filter. In addition, UV absorbing agents can be disposed in any lens component or combination of lens components (e.g., optical filter 104). In some embodiments, the lens may have an UV transmission cutoff at a wavelength from about 380 nm to about 400 nm. In some embodiments, the transmission below about 400 nm, below about 390 nm, or below about 380 nm is less than about 10%, less than about 5%, or less than about 1%. In some embodiments, the lens has a sharp spectral cutoff at about 380 nm, at about 390 nm, or at about 400 nm.

In some embodiments, a photopic transmission of the lens 200 as defined by the EN1836 standard is from about 82% to about 95%, from about 82% to about 92%, from about 84% to about 95%, or from about 85% to about 90%.

In some embodiments, a scotopic transmission of the lens 200 is from about 77% to about 95%, from about 80% to about 90%, or from about 85% to about 90%.

In some embodiments, lens 200 has a blue light transmittance using ANSI Z80.3 (section 3.8.5) from about 55% to about 85%, from about 70% to about 78%, from about 65% to about 75%, less than or equal to about 80%, less than or equal to about 75%, less than or equal to about 74%, less than or equal to about 70%, less than or equal to about 68%, less than or equal to 65%, less than or equal to 62%, or less than or equal to 60%.

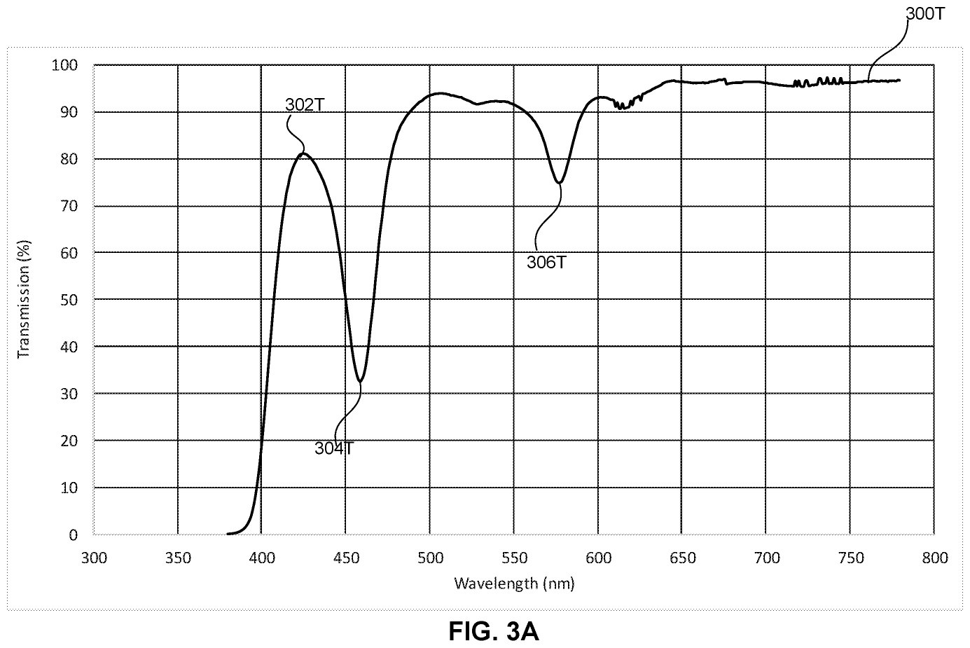

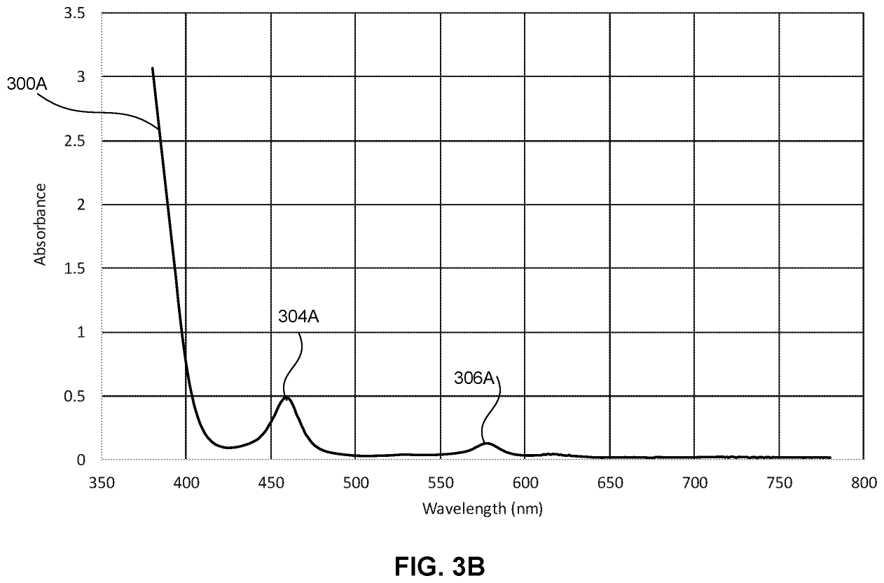

In some embodiments, an average transmittance of a transmittance spectral profile of lens 200 in a spectral range from about 480 nm to about 560 nm is greater than or equal to 80%, greater than or equal to 85%, or greater than or equal to 90% as shown in embodiments FIGS. 3A-10B.

In some embodiments, an average transmittance of lens 200 in a spectral range from about 420 nm to about 450 nm is greater than or equal to 65%, is greater than or equal to 70%, or is greater than or equal to 75%.

In some embodiments, an average transmittance of lens 200 in a spectral range from about 420 nm to about 440 nm is greater than or equal to 70%, greater than or equal to 72%, greater than or equal to 74%, greater than or equal to 76%, greater than or equal to 78%, greater than or equal to 82%, or greater than or equal to 84%.

In some embodiments, the average transmittance in a spectral range of about 425 nm to about 450 nm is greater than about 65%, is greater than about 68%, or is greater than about 70%.

In some embodiments, an average absorptance of the lens 200 in a range from about 380 nm to about 500 nm is less than or equal to 50%, less than or equal to 48%, less than or equal to 46%, less than or equal to 44%, or less than equal to 42%. In some embodiments, an average absorptance of the lens 200 in a range from about 380 nm to about 500 nm is from about 25% to about 50%, from about 30% to about 50%, from about 35% to about 50%, from about 30% to about 40%, or from about 40% to about 50%.

FIG. 2B shows a cross-sectional view of lens 220, according to some embodiments. Lens 220 can be an embodiment of lenses 102A and 102B (shown in FIG. 1) or lens 200 (shown in FIG. 2A). The discussion of lenses 102A and 102 B, and lens 200 applies to lens 220, unless mentioned otherwise. Further, the discussion of elements with the same annotations in FIGS. 1, 2A and 2B applies to each other, unless mentioned otherwise. As shown in FIG. 2B, lens 220 can have front surface 108 and rear surface 110, lens body 208, and a chroma enhancement layer 214 coupled to lens body 208.

Chroma enhancement layer 214 can be placed over lens body 208's front surface 212 and/or lens body 208's rear surface 210. Chroma enhancement layer 214 may be an embodiment of optical filter 104. In some embodiments, chroma enhancement layer 214 can physically contact lens body 208. Chroma enhancement layer 214 can be configured to provide the chroma enhancement for lens 220. Chroma enhancement layer 214 can be further configured to preferentially transmit or attenuate light in the one or more chroma enhancement windows to provide enhanced chroma values. For example, an environment can predominantly reflect or emit a color, where chroma enhancement layer 214 can be adapted to attenuate or enhance an optical transmittance for one or more wavelengths associated with the predominantly reflected or emitted color. In some embodiments, optical filter 104 may also be at least partially incorporated in lens body 208.

In some embodiments, lens 220 can further include one or more functional layer (not shown in FIG. 2B), such as an optical filter configured to provide an optical filtering, an polarizer configured to provide a polarization, an electro-chromic layer configured to provide an electrochromism, a reflection layer configured to provide a partial reflection of incoming visible light, an absorption layer configured to provide a partial or complete absorption of infrared light, a color enhancement layer, a color alteration layer, an anti-static functional layer, an anti-fog functional layer, a scratch resistance layer, a mechanical durability layer, a hydrophobic functional layer, a reflective functional layer, a darkening functional layer, an aesthetic functional layer including tinting, a glue layer, a mechanical protection layer configured to provide mechanical protection to lenses 102A and 102B, to reduce stresses within lens 220, or to improve bonding or adhesion among the layers in lens 220, a physical vapor deposition (PVD) layer, or any combination of these. In some embodiments, the chroma enhancement filter 214 can be at least partially incorporated into the one or more functional layers in lens 220. In some embodiments, the one or more functional layers in lens 220 can be impregnated with, loaded with, or otherwise include the chroma enhancement filters and/or wavelength selective filter.

FIG. 2C shows a cross-sectional view of lens 240, according to some embodiments. Lens 240 can be an embodiment of lenses 102A and 102B shown in FIG. 1, lens 220 shown in FIG. 2A, or lens 220 shown in FIG. 2B. The discussion of lenses 102A, 102B, 200, and 220 applies to lens 240, unless mentioned otherwise. Further, the discussion of elements with the same annotations in FIGS. 1, 2A, 2B, and 2C applies to each other, unless mentioned otherwise.

As shown in FIG. 2C, lens 240 can include lens body 208, a hard coat layer 216 disposed over lens body 208's front surface 212, and a hard coat layer 218 disposed over lens body 208's rear surface 210. Further, lens 240 can also include an anti-reflection layer 222. In some embodiments, lens 240 can also include a second anti-reflection layer 224.

In some embodiments, optical filter 104 may be incorporated or partially incorporated in one or more of the lens body 208, the hard coat layer 216, or the hard coat layer 218. In addition or alternatively, optical filter 104 may be incorporated in one or more chroma enhancement layers such as chroma enhancement layer 214 not shown in FIG. 2C.

In some embodiments, hard coat layers 216 and 218 can include a polymeric material configured to increase an abrasion resistance, a mechanical durability, and/or chemical resistance of lens 240. Hard coat layer 216 can be disposed over lens body 208's front surface 212, and can have a surface 226 facing outwards (e.g., away from eyewear 100's wearer). Hard coat layer 218 can be disposed over lens body 208's rear surface 210, and can have a surface 228 facing inwards (e.g., towards eyewear 100's wearer). In some embodiments, hard coat layer 216 and/or hard coat layer 218 can be impregnated with, loaded with, or otherwise include chroma enhancement filters and selective light wavelength filters.

As a result, hard coat layers 216 and 218 can protect lens body 208 from being damaged (e.g., scratched), thus avoiding degrading lenses 102A and 102B. In some embodiments, hard coat layers 216 and 218 can have substantially identical material and/or thickness to each other.

Anti-reflection layer 222 can be disposed over lens 240's front surface 108 and can be configured to reduce an optical reflectivity from front surface 110 across or over the visible spectral range. As shown in FIG. 2C, anti-reflection layer 222 can be disposed over hard coat layer 216's outward surface 226. In some embodiments, anti-reflection layer 222 can have an exposed surface 232 representing lens 240's front surface 108. In some embodiments, an optical reflectivity from anti-reflection layer 224's surface 230 can be less than about 80%, less than about 60%, less than about 40%, less than about 20%, less than about 15%, less than about 10%, or less than about 5% across or over the visible spectral range.

Anti-reflection layer 224 can be disposed over lens 240's rear surface 110, and can be configured to reduce an optical reflectivity from rear surface 110 across or over the visible spectral range. As shown in FIG. 2C, anti-reflection layer 224 can be disposed over hard coat layer 218's inward surface 228. In some embodiments, anti-reflection layer 224 can have an exposed surface 230 representing lens 240's rear surface 110. In some embodiments, an optical reflectivity from anti-reflection layer 224's surface 230 can be less than about 80%, less than about 60%, less than about 40%, less than about 20%, less than about 15%, less than about 10%, or less than about 5% across or over the visible spectral range.

In some embodiments, lens 240 can further include one or more functional layers (not shown in FIG. 2C), such as an optical filter configured to provide optical filtering, a polarizer configured to provide polarization, an electro-chromic layer configured to provide electrochromism, a reflection layer configured to provide a partial reflection of incoming visible light, an absorption layer configured to provide a partial or complete absorption of infrared light, a color enhancement layer, a color alteration layer, an anti-static functional layer, an anti-fog functional layer, a scratch resistance layer, a mechanical durability layer, a hydrophobic functional layer, a reflective functional layer, a darkening functional layer, an aesthetic functional layer including tinting, a glue layer, a mechanical protection layer configured to provide mechanical protection to lenses 102A and 102B, to reduce stresses within lens 240, or to improve bonding or adhesion among the layers in lens 240, a physical vapor deposition (PVD) layer, or any combination of these.

FIG. 2D shows a cross-sectional view of lens 260, according to some embodiments. Lens 260 can be an embodiment of lenses 102A and 102B shown in FIG. 1, lens 220 shown in FIG. 2A, lens 220 shown in FIG. 2B, or lens 240 shown in FIG. 2C. The discussion of lenses 102A, 102B, 200, 220 and 240 applies to lens 260, unless mentioned otherwise. Further, the discussion of elements with the same annotations in FIGS. 1, 2A, 2B, 2C, and 2D applies to each other, unless mentioned otherwise.

As shown in FIG. 2D, lens 260 can include lens body 208, a hard coat layer 216 disposed over lens body 208's front surface 212, and a hard coat layer 218 disposed over lens body 208's rear surface 210. Further, lens 260 can also include an anti-reflection layer 222. In some embodiments, lens 260 can also include a second anti-reflection layer 224. Further, lens 260 can also include a photochromic layer 234 disposed over the lens body 208 before hard coat layer 216. In some aspects, the photochromic layer 234 can be disposed over the hard coat layer 216. Photochromic layer 234 can include a neutral density photochromic or any other suitable photochromic. In some embodiments, photochromic layer 234 can be formed by spin-coating photochromic dyes over lens body 208's front surface 212 (or over hard coat layer 216's front surface).

In some embodiments, optical filter 104 may be incorporated or partially incorporated in one or more of the lens body 208, the hard coat layer 216, or the hard coat layer 218. In addition or alternatively, optical filter 104 may be incorporated in one or more chroma enhancement layers such as chroma enhancement layer 214, not shown in FIG. 2D. For example, chroma enhancement layer 214 may be coupled to lens body 208. Chroma enhancement layer 214 can be placed over lens body 208's front surface 212 and/or lens body 208's rear surface 210. Chroma enhancement layer 214 can be placed over the photochromic layer 234. In some aspects, chroma enhancement layer 214 can be placed before the photochromic layer 234 over the lens body 208's front surface 212. For example, chroma enhancement layer can be placed before the photochromic layer 234 over the lens body 208's front surface 212 before or after the hard coat layer 216.

In some embodiments, hard coat layers 216 and 218 can include a polymeric material configured to increase an abrasion resistance, a mechanical durability, and/or chemical resistance of lens 260. Hard coat layer 216 can be disposed over lens body 208's front surface 212, and can have a surface 226 facing outwards (e.g., away from eyewear 100's wearer). Hard coat layer 218 can be disposed over lens body 208's rear surface 210, and can have a surface 228 facing inwards (e.g., towards eyewear 100's wearer). In some embodiments, hard coat layer 216 and/or hard coat layer 218 can be impregnated with, loaded with, or otherwise include chroma enhancement filters and selective light wavelength filters.

As a result, hard coat layers 216 and 218 can protect lens body 208 from being damaged (e.g., scratched), thus avoiding degrading lenses 102A and 102B. In some embodiments, hard coat layers 216 and 218 can have substantially identical material and/or thickness to each other.

Anti-reflection layer 222 can be disposed over lens 260's front surface 108 and can be configured to reduce an optical reflectivity from front surface 108 across or over the visible spectral range. As shown in FIG. 2D, anti-reflection layer 222 can be disposed over hard coat layer 216's outward surface 226 or over photochromic layer 234. In some embodiments, anti-reflection layer 222 can have an exposed surface 232 representing lens 260's front surface 108. In some embodiments, an optical reflectivity from anti-reflection layer 224's surface 230 can be less than about 80%, less than about 60%, less than about 40%, less than about 20%, less than about 15%, less than about 10%, less than about 5%, or less than 2% across or over the visible spectral range.

Anti-reflection layer 224 can be disposed over lens 260's rear surface 110, and can be configured to reduce an optical reflectivity from rear surface 110 across or over the visible spectral range. As shown in FIG. 2D, anti-reflection layer 224 can be disposed over hard coat layer 218's inward surface 228. In some embodiments, anti-reflection layer 224 can have an exposed surface 230 representing lens 260's rear surface 110. In some embodiments, an optical reflectivity from anti-reflection layer 224's surface 230 can be less than about 80%, less than about 60%, less than about 40%, less than about 20%, less than about 15%, less than about 10%, less than about 5%, or less than 2% across or over the visible spectral range.

In some embodiments, lens 260 can further include one or more functional layers (not shown in FIG. 2D), such as an optical filter configured to provide optical filtering, a polarizer configured to provide polarization, an electro-chromic layer configured to provide electrochromism, a reflection layer configured to provide a partial reflection of incoming visible light, an absorption layer configured to provide a partial or complete absorption of infrared light, a color enhancement layer, a color alteration layer, an anti-static functional layer, an anti-fog functional layer, a scratch resistance layer, a mechanical durability layer, a hydrophobic functional layer, a reflective functional layer, a darkening functional layer, an aesthetic functional layer including tinting, a glue layer, a mechanical protection layer configured to provide mechanical protection to lenses 102A and 102B, to reduce stresses within lens 260, or to improve bonding or adhesion among the layers in lens 260, a physical vapor deposition (PVD) layer, or any combination of these.

In some embodiments, lens 260 incorporating one or more photochromic layers can provide relatively little light attenuation when used in a lower light environment, but can automatically provide increased light attenuation when used in bright light, such as when worn outdoors. Thus, in some embodiments, the lens can be suitable for use in both indoor and outdoor environments. In certain embodiments, the photochromic compositions can selectively alter the selective wavelength filtering of the lens. For example, the lens can minimize transmission of wavelengths associated with OLED devices when used in a lower light environment, and minimize transmission of undesirable wavelengths emitted by the sun when used in bright light. A benefit of embodiments of the present disclosure is to effectively provide an eyewear having selective light wavelength filtering and chroma enhancement, thus suitable when using OLED devices while maintaining high transmittance in a lower light environment (when UV protection is not needed) and effectively provide an eyewear having filtering for undesirable wavelengths (UV) when used in bright light. The lens can provide increased blue light protection in bright light (outdoor) while maintaining high transmittance and protection from wavelengths associated with OLED devices in low light environment (e.g., indoor). In some embodiments, the blue light transmittance of the lens can have a high transmittance in a light state (e.g., in the low light environment) and low transmittance in a dark state (e.g., in bright light). Thus, the lens provides optimal transition between bright light and low light environment without compromising transmission or protection from undesired wavelengths.

In some embodiments, lens 260 can have a bronze or dark grey appearance when in the dark state (i.e., photochromic activated) and lens 260 can have a clear appearance when in the light state (i.e., photochromic non-activated).

FIG. 3A illustrates an optical transmittance profile 300T, according to some embodiments. FIG. 3B illustrates a respective optical absorbance profile 300A, according to some embodiments. It would be understood that optical characteristics exhibited in FIGS. 3A and 3B are merely illustrative and not intended to be limiting, unless mentioned otherwise. For example, optical transmittance profile 300T can represent an optical transmittance of optical filter 104, lens 200, lens 220, or lens 240 that includes a selective light wavelength filter and chroma enhancement filter.

Optical transmittance profile 300T can include one or more transmittance valleys, such as valleys 304T and 306T, each having a minimum transmittance in one or more spectral bands. Such transmittance valleys (e.g., valleys 304T, 306T) can filter out or attenuate undesired spectral wavelengths of light. Accordingly, optical transmittance profile 300T can provide chroma enhancement and selective wavelength filtering in the one or more spectral bands. Optical transmittance profile 300T can also include one or more transmittance peaks such as peak 302T.

A transmittance valley can be defined by a position of a minimum optical transmittance in a middle portion of a spectral band between lower and upper edge portions of the spectral band, the lower and upper edge portions having an optical transmittance that is substantially greater than the minimum optical transmittance. On the other hand, an absorbance peak can be defined by a position of a maximum absorbance in a middle portion of a spectral band between lower and upper edge portions of the spectral band, the upper and lower edge portions having an optical absorbance substantially below the maximum absorbance. An optical transmittance valley can be associated with a respective optical absorbance peak. For example, an optical filter can have an optical characteristic including an optical reflectivity R, an optical transmittance T, an optical absorptance A_{P}, and an optical absorbance A_{B}. Optical absorptance A_{P} can be about equal to (1-T-R), and optical absorbance A_{B} can be about equal to the magnitude of the logarithm of optical transmittance T, such as −log₁₀(T). In some embodiments, the optical reflectivity R can be relatively wavelength-insensitive as compared to the optical transmittance T, the optical absorptance A_{P}, and the optical absorbance A_{B}. Therefore, in some embodiments, the optical transmittance valley and the respective absorbance peak can be positioned at about the same wavelength. Accordingly, each of the transmittance valleys in a spectrum can be regarded as an absorbance peak in the spectrum. For example, each of valleys 304T and 306T illustrated in optical transmittance profile 300T can be hereinafter represented as absorbance peaks 304A and 306A in optical absorbance profile 300A. As such, in referring to FIG. 3B, optical absorbance profile 300A can include an absorbance peak 304A associated with valley 304T and an absorbance peak 306A associated with valley 306T. Absorbance peak 304A can have a maximum optical density (e.g., optical absorbance A_{B}) from about 0.25 to about 0.75, from about 0.3 to about 0.7, from about 0.4 to about 0.6, or from about 0.45 to about 0.5, and can be positioned in a spectral band from about 450 nm and about 500 nm, from about 450 nm to about 475 nm, from about 450 nm to about 470 nm, or from about 455 nm to about 465 nm. Accordingly, optical densities at a lower edge portion (e.g., closer to about 450 nm) and a upper edge portion (e.g., closer to about 500 nm) of the spectral band (e.g., between about 450 nm and about 500 nm) can be less than that of absorbance peak 304A. Namely, absorbance peak 304A can have greater absorbance than the lower edge and the upper edge portions of the spectral band. Similarly, absorbance peak 306A can have a maximum optical density less than or equal to 0.2, less than or equal to 0.15, or less than or equal to 0.1, and can be positioned in a spectral band from about 570 nm to about 590 nm.

In some embodiments, the minimum transmittance of the transmittance valley 304T is positioned at a wavelength from about 450 nm to about 475 nm, from about 450 nm to about 470 nm, from about 455 nm to about 470 nm, from about 455 nm to about 465 nm, at about 459 nm, at about 460 nm, or at about 461 nm.

In some embodiments, a minimum transmittance of the first valley 304T is from about 18% to about 40%, from about 20% to about 40%, or from about 25% to about 35%.

In some embodiments, absorbance peak 304A can have a maximum optical density from about 0.4 to about 0.8, from about 0.5 to about 0.75, from about 0.5 to about 0.7, from about 0.5 to about 0.65, or from about 0.45 to about 0.5.

Each transmittance valley in optical transmittance profile 300T can have a respective transmittance bandwidth defined as a full width of the each transmittance valley at certain offset from the minimum transmittance of the each transmittance valley, such as the minimum transmittance plus 1%, the minimum transmittance plus 5%, the minimum transmittance plus 10%, the minimum transmittance plus 15%, or the minimum transmittance plus 30%. For example, if the minimum transmittance is 20%, the bandwidth of the minimum transmittance plus 10% would be measured as corresponding to 30% transmittance. In some embodiments, transmittance valley 304T can have a transmittance bandwidth of less than about 5 nm, less than about 10 nm, less than about 15 nm, less than about 20 nm, or less than about 25 nm at minimum transmittance plus 1%, the minimum transmittance plus 5%, the minimum transmittance plus 10%, the minimum transmittance plus 15%, or the minimum transmittance plus 30%, respectively.

In some embodiments, transmittance valley 304T can have a transmittance bandwidth at the minimum transmittance plus 30% from about 20 nm to about 30 nm, from about 22 nm to about 27 nm, or about 25 nm.

In some embodiments, transmittance valley 306T can have a transmittance bandwidth of less than about 50 nm, less than about 40 nm, less than about 30 nm, less than about 20 nm, less than about 15 nm, or less than about 10 nm at the minimum transmittance plus 5%.

In some embodiments, the maximum transmittance of the transmittance peak 302T is greater than or equal to about 60%, is greater than or equal to about 70%, is greater than or equal to about 75%, or is greater than or equal to about 80%.

In some embodiments, the maximum transmittance of transmittance peak 302T is at a wavelength from about 410 nm to about 450 nm, from about 420 nm to about 440 nm, or from about 420 nm to about 430 nm.

In some embodiments, a minimum transmittance of the second valley 306T is from about 70% to about 85%, from about from about 72% to about 80%, or at about 75%.

In some embodiments, the minimum transmittance of second valley 306T is at a wavelength from about 570 nm to about 590 nm, from about 575 nm to about 585 nm, or from about 575 nm to about 580 nm.

In some embodiments, an E313 yellowness index of optical filter 104, lens 200, lens 220, or lens 240 is from about 15 to about 35, is from about 25 to about 35, is from about 25 to 30.

In some embodiments, optical filter 104, lens 200, lens 220, or lens 240 has an ultraviolet (UV) transmission cutoff at a wavelength from about 380 nm to about 400 nm or about 380 nm.

In some embodiments, the average transmittance in a spectral range of about 425 nm to about 450 nm is greater than about 65%, is greater than about 68%, or is greater than about 70%.

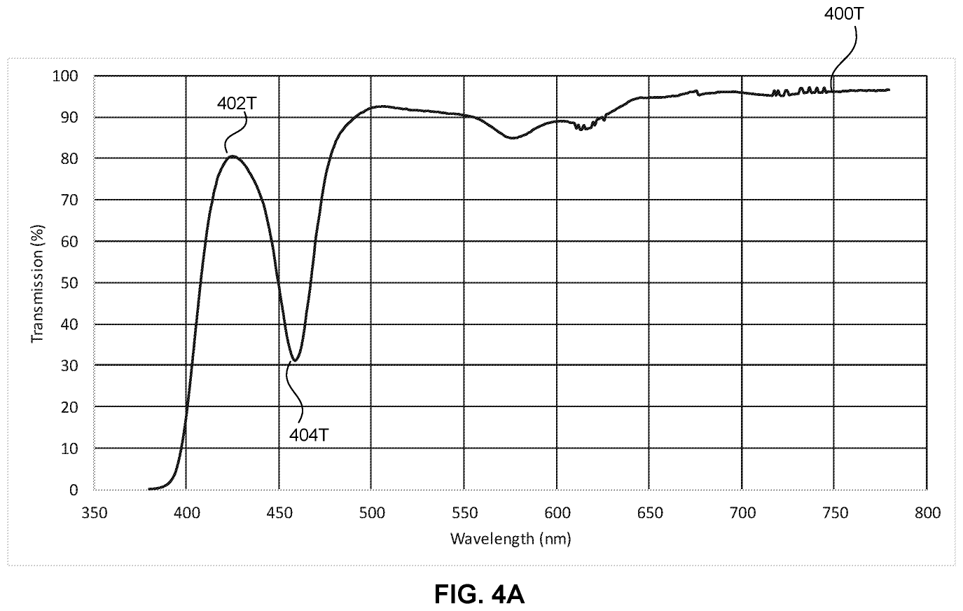

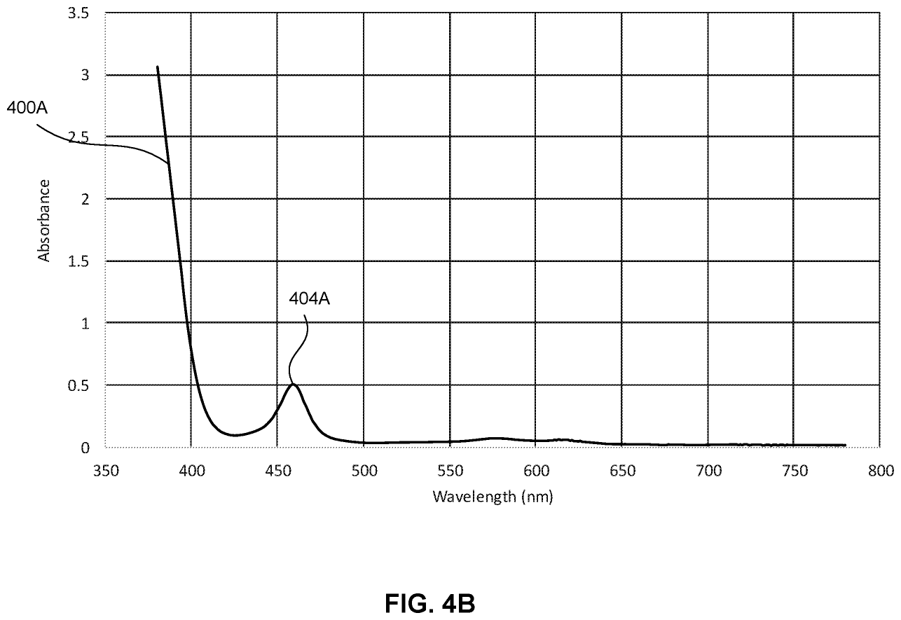

FIG. 4A illustrates an optical transmittance profile 400T, according to some embodiments. FIG. 4B illustrates a respective optical absorbance profile 400A, according to some embodiments. It would be understood that optical characteristics exhibited in FIGS. 4A and 4B are merely illustrative and not intended to be limiting, unless mentioned otherwise. For example, optical transmittance profile 400T can represent an optical transmittance of optical filter 104, lens 200, lens 220, or lens 240 that includes a selective light wavelength filter.

Optical transmittance profile 400T can include one or more transmittance valleys, such as valley 404T having a minimum transmittance in one or more spectral bands, and one or more transmittance peaks such as peak 402T, Such transmittance valleys (e.g., valley 404T) can filter out or attenuate undesired spectral wavelengths of light. Accordingly, optical transmittance profile 400T can provide selective filtering in the one or more spectral bands. As discussed previously herein, each of the transmittance valleys in a spectrum can be regarded as an absorbance peak in the spectrum. For example, valley 404T illustrated in optical transmittance profile 400T can be hereinafter represented as absorbance peak 404A in optical absorbance profile 400A. As such, in referring to FIG. 4B, optical absorbance profile 400A can include an absorbance peak 404A associated with valley 404T.

In some embodiments, the minimum transmittance of the transmittance valley 404T is positioned at a wavelength from about 450 nm to about 475 nm, from about 450 nm to about 470 nm, from about 455 nm to about 470 nm, from about 455 nm to about 465 nm, at about 459 nm, at about 460 nm, or at about 461 nm.

In some embodiments, a minimum transmittance of the first valley 404T is from about 18% to about 40%, from about 25% to about 40%, or from about 30% to about 35%.

In some embodiments, absorbance peak 404A can have a maximum optical density from about 0.4 to about 0.8, from about 0.45 to about 0.75, from about 0.5 to about 0.7, from about 0.4 to about 0.6, or from about 0.45 to about 0.5.

Each transmittance valley in optical transmittance profile 400T can have a respective transmittance bandwidth defined as a full width of the each transmittance valley at certain offset from the minimum transmittance of the each transmittance valley, such as the minimum transmittance plus 1%, the minimum transmittance plus 5%, the minimum transmittance plus 10%, the minimum transmittance plus 15%, or the minimum transmittance plus 30%. In some embodiments, transmittance valley 404T can have a transmittance bandwidth of less than about 5 nm, less than about 10 nm, less than about 15 nm, less than about 20 nm, or less than about 25 nm at minimum transmittance plus 1%, the minimum transmittance plus 5%, the minimum transmittance plus 10%, the minimum transmittance plus 15%, or the minimum transmittance plus 30%, respectively.

In some embodiments, transmittance valley 404T can have a transmittance bandwidth at the minimum transmittance plus 30% from about 20 nm to about 30 nm, from about 22 nm to about 27 nm, or about 25 nm.

In some embodiments, the maximum transmittance of the transmittance peak 402T is greater than or equal to about 60%, is greater than or equal to about 70%, is greater than or equal to about 75%, or is greater than or equal to about 80%.

In some embodiments, the maximum transmittance of transmittance peak 402T is at a wavelength from about 410 nm to about 450 nm, from about 420 nm to about 440 nm, or from about 420 nm to about 430 nm.

In some embodiments, an E313 yellowness index of the optical filter 104, lens 200, lens 220, or lens 240 is from about 15 to about 35, is from about 25 to about 35, is from about 25 to 30.

In some embodiments, optical filter 104, lens 200, lens 220, or lens 240 has an ultraviolet (UV) transmission cutoff at a wavelength from about 380 nm to about 400 nm or about 380 nm.

In some embodiments, the average transmittance in a spectral range of about 425 nm to about 450 nm is greater than about 65%, is greater than about 68%, or is greater than about 70%.

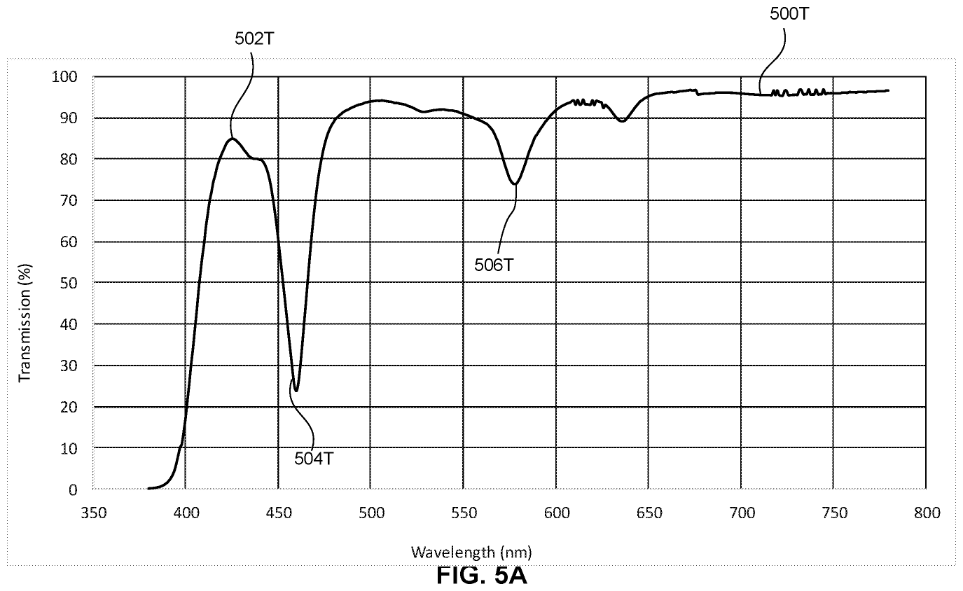

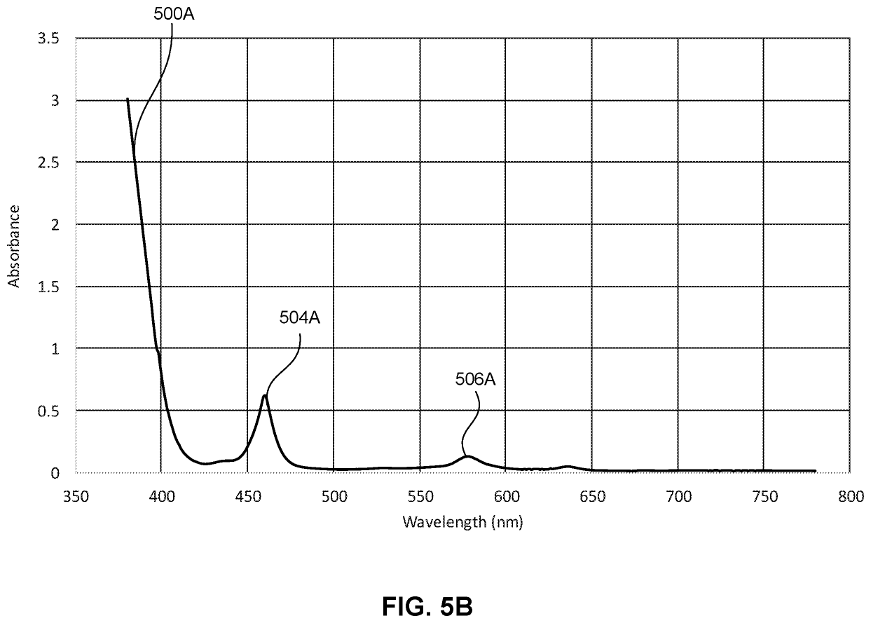

FIG. 5A illustrates an optical transmittance profile 500T, according to some embodiments. FIG. 5B illustrates a respective optical absorbance profile 500A, according to some embodiments. It would be understood that optical characteristics exhibited in FIGS. 5A and 5B are merely illustrative and not intended to be limiting, unless mentioned otherwise. For example, optical transmittance profile 500T can represent an optical transmittance of optical filter 104, lens 200, lens 220, or lens 240 that includes a selective light wavelength filter and a chroma enhancement filter.

Optical transmittance profile 500T can include one or more transmittance valleys, such as valleys 504T and 506T, each having a minimum transmittance in one or more spectral bands. Such transmittance valleys (e.g., valleys 504T, 506T) can filter out or attenuate undesired spectral wavelengths of light. Accordingly, optical transmittance profile 500T can provide chroma enhancement and selective wavelength filtering in the one or more spectral bands. Optical transmittance profile 500T can also include one or more transmittance peaks such as peak 502T.

As discussed previously herein, each of the transmittance valleys in a spectrum can be regarded as an absorbance peak in the spectrum. For example, valleys 504T, 506T illustrated in optical transmittance profile 500T can be hereinafter represented as absorbance peaks 504A, 506A in optical absorbance profile 500A. As such, in referring to FIG. 5B, optical absorbance profile 500A can include absorbance peak 504A, 506A associated with valleys 504T, 506T.

In some embodiments, the minimum transmittance of the transmittance valley 504T is positioned at a wavelength from about 450 nm to about 475 nm, from about 450 nm to about 470 nm, from about 455 nm to about 470 nm, from about 455 nm to about 465 nm, at about 459 nm, at about 460 nm, or at about 461 nm.

In some embodiments, a minimum transmittance of the first valley 504T is from about 15% to about 40%, from about 20% to about 35%, from about 20% to about 30%, about 22% to about 27%, or about 23%, about 24%, about 25%, or about 26%.

In some embodiments, absorbance peak 504A can have a maximum optical density from about 0.4 to about 0.8, from about 0.4 to about 0.7, from about 0.45 to about 0.65, from about 0.55 to about 0.65, or from about 0.6 to about 0.65.

Each transmittance valley in optical transmittance profile 500T can have a respective transmittance bandwidth defined as a full width of the each transmittance valley at certain offset from the minimum transmittance of the each transmittance valley, such as the minimum transmittance plus 1%, the minimum transmittance plus 5%, the minimum transmittance plus 10%, the minimum transmittance plus 15%, or the minimum transmittance plus 30%. In some embodiments, transmittance valley 504T can have a transmittance bandwidth of less than about 3 nm, less than about 5 nm, less than about 10 nm, less than about 15 nm, or less than about 20 nm at minimum transmittance plus 1%, the minimum transmittance plus 5%, the minimum transmittance plus 10%, the minimum transmittance plus 15%, or the minimum transmittance plus 30%, respectively.

In some embodiments, transmittance valley 504T can have a transmittance bandwidth at the minimum transmittance plus 30% from about 10 nm to about 20 nm, from about 12 nm to about 17 nm, or about 15 nm.

In some embodiments, transmittance valley 506T can have a transmittance bandwidth of less than about 50 nm, less than about 40 nm, less than about 30 nm, less than about 20 nm, less than about 15 nm, or less than about 10 nm at the minimum transmittance plus 5%.

In some embodiments, the maximum transmittance of the transmittance peak 502T is greater than or equal to about 60%, is greater than or equal to about 70%, is greater than or equal to about 75%, or is greater than or equal to about 80%.

In some embodiments, the maximum transmittance of transmittance peak 502T is at a wavelength from about 410 nm to about 450 nm, from about 420 nm to about 440 nm, or from about 420 nm to about 430 nm.

In some embodiments, a minimum transmittance of the second valley 506T is from about 70% to about 85%, from about from about 72% to about 80%, at about 75%, or at about 74%.

In some embodiments, the minimum transmittance of second valley 506T is at a wavelength from about 570 nm to about 590 nm, from about 575 nm to about 585 nm, or from about 575 nm to about 580 nm.

In some embodiments, an E313 yellowness index of the optical filter 104, lens 200, lens 220, or lens 240 is from about 15 to about 35, is from about 15 to about 30, or is from about 20 to 25.

In some embodiments, the optical filter 104, lens 200, lens 220, or lens 240 has an ultraviolet (UV) transmission cutoff at a wavelength from about 380 nm to about 400 nm, or about 380 nm.

In some embodiments, the average transmittance in a spectral range of about 425 nm to about 450 nm is greater than about 65%, is greater than about 68%, is greater than about 70%, or is greater than about 75%.

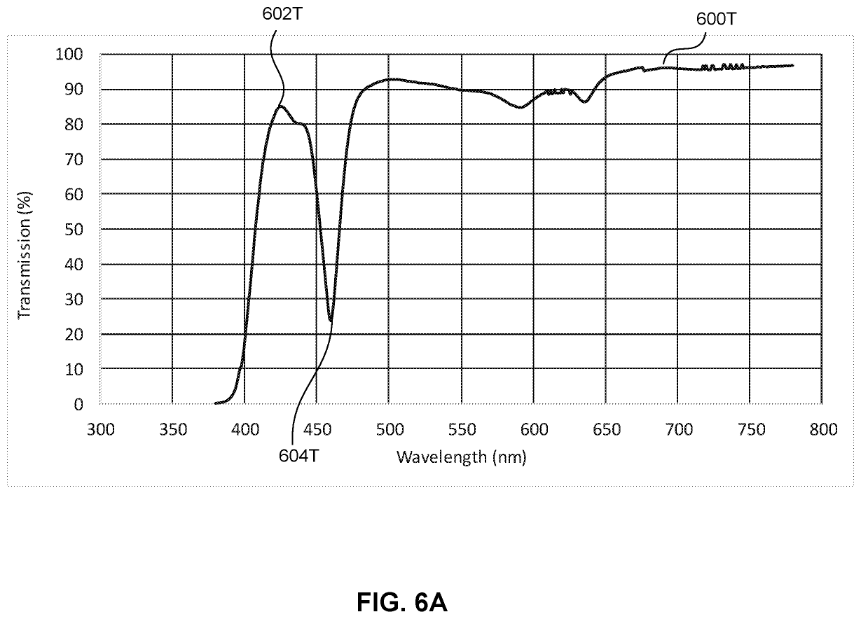

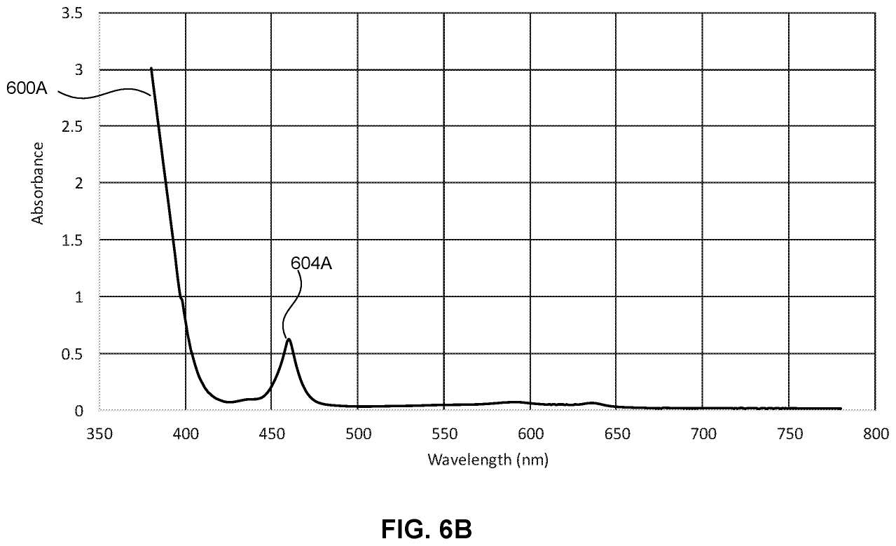

FIG. 6A illustrates an optical transmittance profile 600T, according to some embodiments. FIG. 6B illustrates a respective optical absorbance profile 600A, according to some embodiments. It would be understood that optical characteristics exhibited in FIGS. 6A and 6B are merely illustrative and not intended to be limiting, unless mentioned otherwise. For example, optical transmittance profile 600T can represent an optical transmittance of optical filter 104, lens 200, lens 220, or lens 240 that includes a selective light wavelength filter.

Optical transmittance profile 600T can include one or more transmittance valleys, such as valley 604T having a minimum transmittance in one or more spectral bands, and one or more transmittance peaks such as peak 602T, Such transmittance valleys (e.g., valley 604T) can filter out or attenuate undesired spectral wavelengths of light. Accordingly, optical transmittance profile 600T can provide selective filtering in the one or more spectral bands. As discussed previously herein, each of the transmittance valleys in a spectrum can be regarded as an absorbance peak in the spectrum. For example, valley 604T illustrated in optical transmittance profile 600T can be hereinafter represented as absorbance peak 604A in optical absorbance profile 600A. As such, in referring to FIG. 6B, optical absorbance profile 600A can include an absorbance peak 604A associated with valley 604T.

In some embodiments, the minimum transmittance of the transmittance valley 604T is positioned at a wavelength from about 450 nm to about 475 nm, from about 450 nm to about 470 nm, from about 455 nm to about 470 nm, from about 455 nm to about 465 nm, at about 459 nm, at about 460 nm, or at about 461 nm.

In some embodiments, a minimum transmittance of the first valley 604T is from about 15% to about 40%, from about 20% to about 35%, or from about 22% to about 27%.

In some embodiments, absorbance peak 604A can have a maximum optical density from about 0.4 to about 0.8, from about 0.4 to about 0.7, from about 0.5 to about 0.65, or from about 0.55 to about 0.65.

Each transmittance valley in optical transmittance profile 600T can have a respective transmittance bandwidth defined as a full width of the each transmittance valley at certain offset from the minimum transmittance of the each transmittance valley, such as the minimum transmittance plus 1%, the minimum transmittance plus 5%, the minimum transmittance plus 10%, the minimum transmittance plus 15%, or the minimum transmittance plus 30%. In some embodiments, transmittance valley 604T can have a transmittance bandwidth of less than about 3 nm, less than about 5 nm, less than about 10 nm, less than about 15 nm, or less than about 20 nm at minimum transmittance plus 1%, the minimum transmittance plus 5%, the minimum transmittance plus 10%, the minimum transmittance plus 15%, or the minimum transmittance plus 30%, respectively.

In some embodiments, transmittance valley 604T can have a transmittance bandwidth at the minimum transmittance plus 30% from about 10 nm to about 20 nm, from about 12 nm to about 17 nm, about 16 nm, or about 15 nm.

In some embodiments, the maximum transmittance of the transmittance peak 602T is greater than or equal to about 60%, is greater than or equal to about 70%, is greater than or equal to about 75%, or is greater than or equal to about 80%.

In some embodiments, the maximum transmittance of transmittance peak 602T is at a wavelength from about 410 nm to about 450 nm, from about 420 nm to about 440 nm, or from about 420 nm to about 430 nm.

In some embodiments, an E313 yellowness index of optical filter 104, lens 200, lens 220, or lens 240 is from about 15 to about 35, is from about 20 to about 30, or is from about 20 to 25.

In some embodiments, optical filter 104, lens 200, lens 220, or lens 240 has an UV transmission cutoff at a wavelength from about 380 nm to about 400 nm or about 380 nm.

In some embodiments, the average transmittance in a spectral range of about 425 nm to about 450 nm is greater than about 65%, is greater than about 68%, is greater than about 70%, or is greater than about 75%.

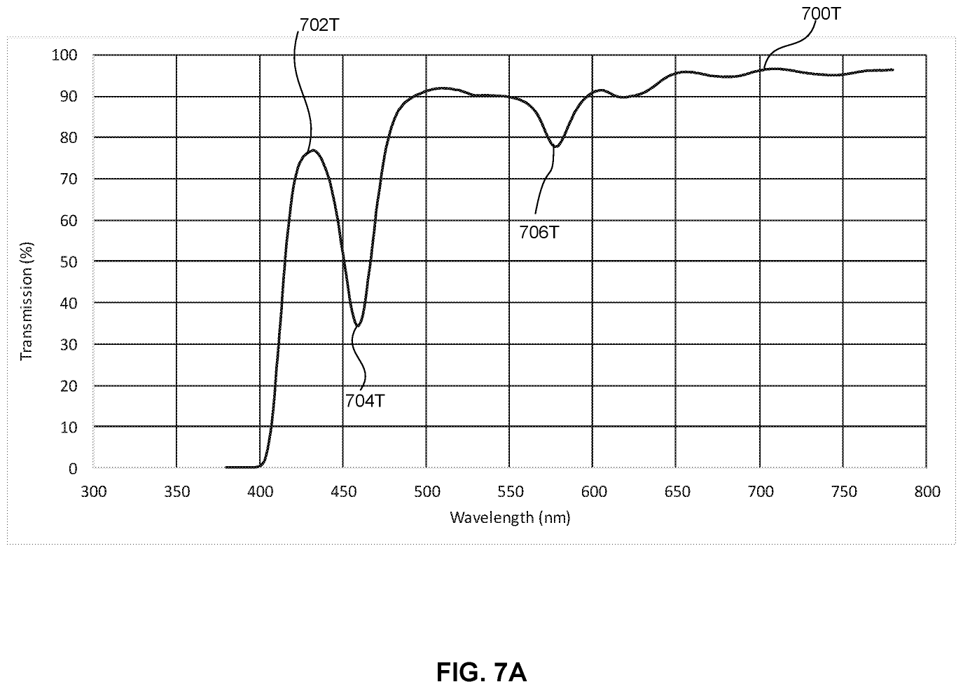

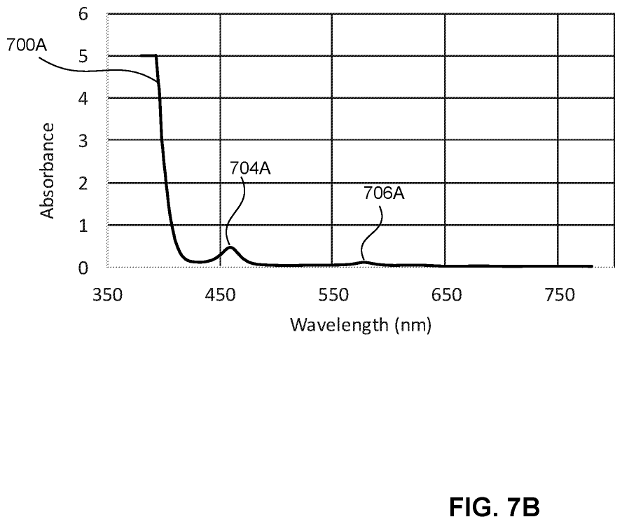

FIG. 7A illustrates an optical transmittance profile 700T, according to some embodiments. FIG. 7B illustrates a respective optical absorbance profile 700A, according to some embodiments. It would be understood that optical characteristics exhibited in FIGS. 7A and 7B are merely illustrative and not intended to be limiting, unless mentioned otherwise. For example, optical transmittance profile 700T can represent an optical transmittance of optical filter 104, lens 200, lens 220, or lens 240 that includes a selective light wavelength filter and a chroma enhancement filter.

Optical transmittance profile 700T can include one or more transmittance valleys, such as valleys 704T and 706T, each having a minimum transmittance in one or more spectral bands. Such transmittance valleys (e.g., valleys 704T, 706T) can filter out or attenuate undesired spectral wavelengths of light. Accordingly, optical transmittance profile 700T can provide chroma enhancement and selective wavelength filtering in the one or more spectral bands. Optical transmittance profile 700T can also include one or more transmittance peaks such as peak 702T.

As discussed previously herein, each of the transmittance valleys in a spectrum can be regarded as an absorbance peak in the spectrum. For example, valleys 704T, 706T illustrated in optical transmittance profile 700T can be hereinafter represented as absorbance peaks 704A, 706A in optical absorbance profile 700A. As such, in referring to FIG. 7B, optical absorbance profile 700A can include absorbance peaks 704A, 706A associated with valleys 704T, 706T.

In some embodiments, the minimum transmittance of the transmittance valley 704T is positioned at a wavelength from about 450 nm to about 475 nm, from about 450 nm to about 470 nm, from about 455 nm to about 470 nm, from about 455 nm to about 465 nm, at about 459 nm, at about 460 nm, or at about 461 nm.

In some embodiments, a minimum transmittance of the first valley 704T is from about 15% to about 40%, from about 20% to about 40%, from about 30% to about 40%, or about 30% to about 35%.

In some embodiments, absorbance peak 704A can have a maximum optical density from about 0.4 to about 0.8, about 0.4 to about 0.7, from about 0.45 to about 0.65, from about 0.55 to about 0.65, or from about 0.6 to about 0.65.

Each transmittance valley in optical transmittance profile 700T can have a respective transmittance bandwidth defined as a full width of the each transmittance valley at certain offset from the minimum transmittance of the each transmittance valley, such as the minimum transmittance plus 1%, the minimum transmittance plus 5%, the minimum transmittance plus 10%, the minimum transmittance plus 15%, or the minimum transmittance plus 30%. In some embodiments, transmittance valley 704T can have a transmittance bandwidth of less than about 5 nm, less than about 10 nm, less than about 15 nm, less than about 20 nm, or less than about 30 nm at minimum transmittance plus 1%, the minimum transmittance plus 5%, the minimum transmittance plus 10%, the minimum transmittance plus 15%, or the minimum transmittance plus 30%, respectively.

In some embodiments, transmittance valley 704T can have a transmittance bandwidth at the minimum transmittance plus 30% from about 20 nm to about 30 nm, from about 22 nm to about 27 nm, or about 25 nm.

In some embodiments, transmittance valley 706T can have a transmittance bandwidth of less than about 50 nm, less than about 40 nm, less than about 30 nm, less than about 20 nm, less than about 15 nm, or less than about 10 nm at the minimum transmittance plus 5%.

In some embodiments, the maximum transmittance of the transmittance peak 702T is greater than or equal to about 60%, is greater than or equal to about 65%, or is greater than or equal to about 70%.

In some embodiments, the maximum transmittance of transmittance peak 702T is at a wavelength from about 410 nm to about 450 nm, from about 420 nm to about 440 nm, or from about 420 nm to about 430 nm.

In some embodiments, a minimum transmittance of the second valley 706T is from about 70% to about 85%, from about from about 72% to about 80%, or from about 75% to about 80%.

In some embodiments, the minimum transmittance of second valley 706T is at a wavelength from about 570 nm to about 590 nm, from about 575 nm to about 585 nm, or from about 575 nm to about 580 nm.

In some embodiments, an E313 yellowness index of optical filter 104, lens 200, lens 220, or lens 240 is from about 15 to about 35, is from about 20 to about 35, or is from about 25 to about 33.

In some embodiments, optical filter 104, lens 200, lens 220, or lens 240 has a UV transmission cutoff at a wavelength from about 380 nm to about 400 nm, or about 400 nm.

In some embodiments, the average transmittance in a spectral range of about 425 nm to about 450 nm is greater than about 65%, is greater than about 68%, or is greater than about 70%.

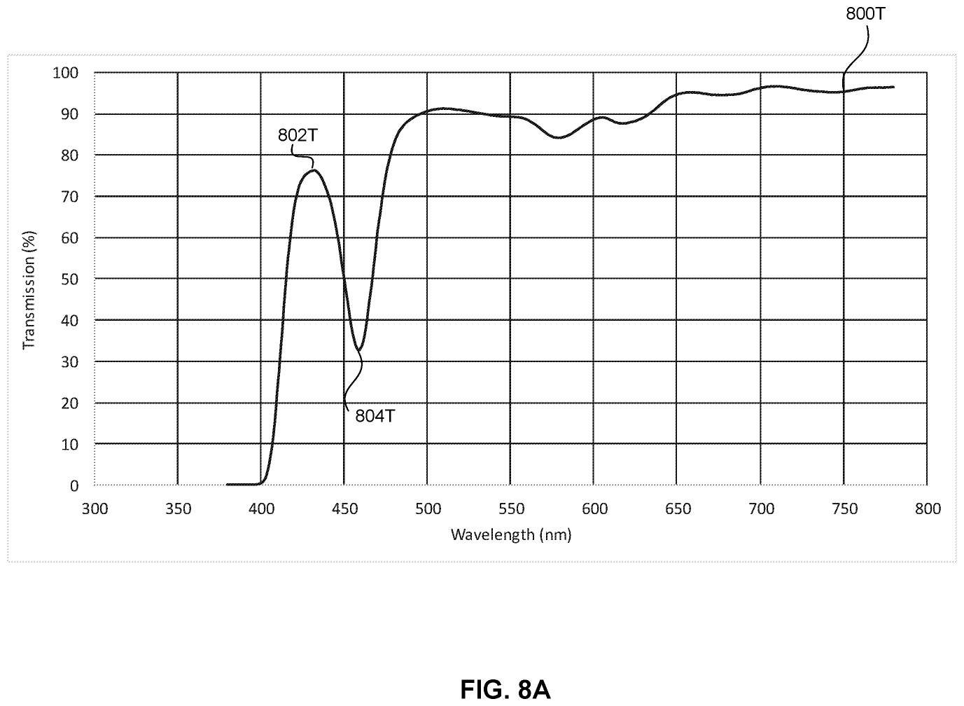

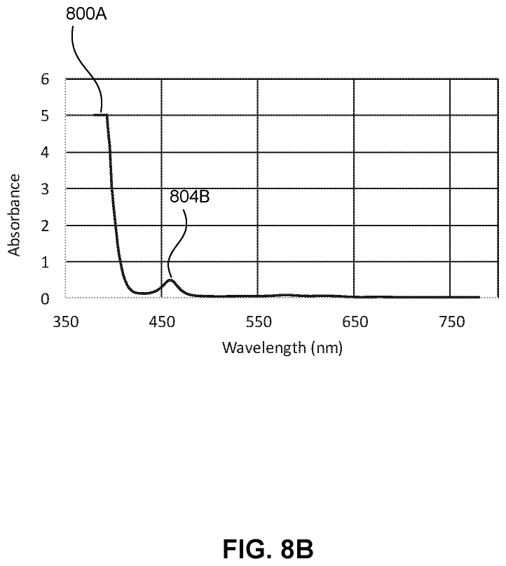

FIG. 8A illustrates an optical transmittance profile 800T, according to some embodiments. FIG. 8B illustrates a respective optical absorbance profile 800A, according to some embodiments. It would be understood that optical characteristics exhibited in FIGS. 8A and 8B are merely illustrative and not intended to be limiting, unless mentioned otherwise. For example, optical transmittance profile 800T can represent an optical transmittance of optical filter 104, lens 200, lens 220, or lens 240 that includes a selective light wavelength filter.

Optical transmittance profile 800T can include one or more transmittance valleys, such as valley 804T having a minimum transmittance in one or more spectral bands, and one or more transmittance peaks such as peak 802T, Such transmittance valleys (e.g., valley 804T) can filter out or attenuate undesired spectral wavelengths of light. Accordingly, optical transmittance profile 800T can provide selective filtering in the one or more spectral bands. As discussed previously herein, each of the transmittance valleys in a spectrum can be regarded as an absorbance peak in the spectrum. For example, valley 804T illustrated in optical transmittance profile 800T can be hereinafter represented as absorbance peak 804A in optical absorbance profile 800A. As such, in referring to FIG. 8B, optical absorbance profile 800A can include an absorbance peak 804A associated with valley 804T.

In some embodiments, the minimum transmittance of the transmittance valley 804T is positioned at a wavelength from about 450 nm to about 475 nm, from about 450 nm to about 470 nm, from about 455 nm to about 470 nm, from about 455 nm to about 465 nm, at about 459 nm, at about 460 nm, or at about 461 nm.

In some embodiments, a minimum transmittance of the first valley 804T is from about 15% to about 40%, from about 20% to about 40%, or from about 25% to about 35%, from about 25% to about 40%, from about 30% to about 40%, or from about 30% to about 35%.

In some embodiments, absorbance peak 804A can have a maximum optical density from about 0.4 to about 0.8, about 0.4 to about 0.7, from about 0.4 to about 0.6, from about 0.4 to about 0.5, or from about 0.45 to about 0.5.

Each transmittance valley in optical transmittance profile 800T can have a respective transmittance bandwidth defined as a full width of the each transmittance valley at certain offset from the minimum transmittance of the each transmittance valley, such as the minimum transmittance plus 1%, the minimum transmittance plus 5%, the minimum transmittance plus 10%, the minimum transmittance plus 15%, or the minimum transmittance plus 30%. In some embodiments, transmittance valley 804T can have a transmittance bandwidth of less than about 5 nm, less than about 10 nm, less than about 15 nm, less than about 20 nm, or less than about 30 nm at minimum transmittance plus 1%, the minimum transmittance plus 5%, the minimum transmittance plus 10%, the minimum transmittance plus 15%, or the minimum transmittance plus 30%, respectively.

In some embodiments, transmittance valley 804T can have a transmittance bandwidth at the minimum transmittance plus 30% from about 20 nm to about 30 nm, from about 22 nm to about 27 nm, or about 25 nm.

In some embodiments, the maximum transmittance of the transmittance peak 802T is greater than or equal to about 60%, is greater than or equal to about 65% or is greater than or equal to about 70%.

In some embodiments, the maximum transmittance of transmittance peak 802T is at a wavelength from about 410 nm to about 450 nm, from about 420 nm to about 440 nm, or from about 420 nm to about 430 nm.

In some embodiments, an E313 yellowness index of optical filter 104, lens 200, lens 220, or lens 240 is from about 15 to about 35, is from about 20 to about 35, is from about 25 to about 35, or is from about 30 to 35.

In some embodiments, optical filter 104, lens 200, lens 220, or lens 240 has an UV transmission cutoff at a wavelength from about 380 nm to about 400 nm or about 400 nm.

In some embodiments, the average transmittance in a spectral range of about 425 nm to about 450 nm is greater than about 65%, or is greater than about 68%.

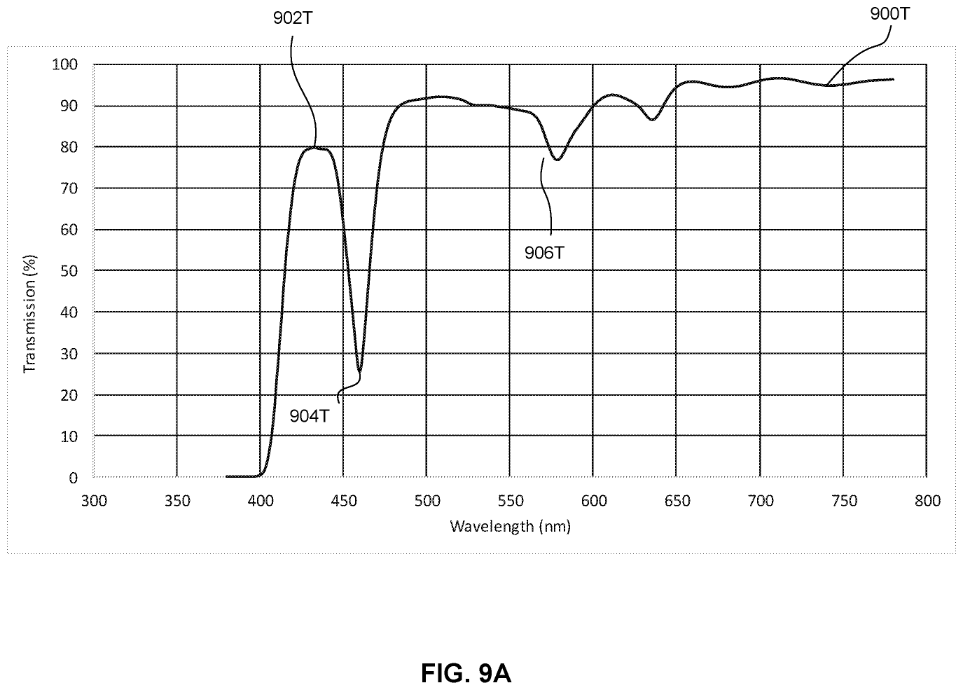

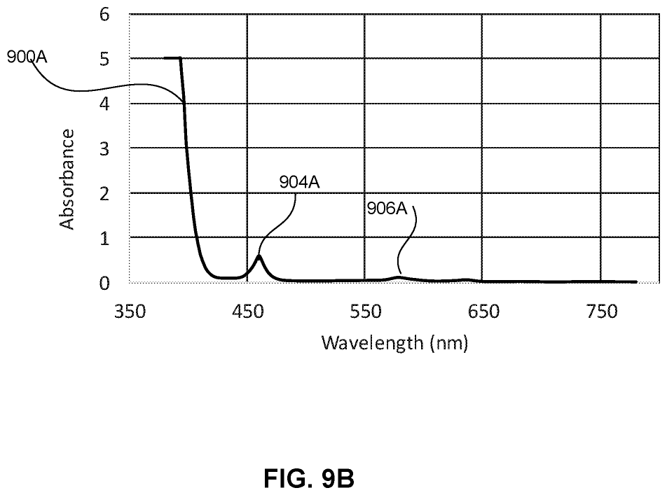

FIG. 9A illustrates an optical transmittance profile 900T, according to some embodiments. FIG. 9B illustrates a respective optical absorbance profile 900A, according to some embodiments. It would be understood that optical characteristics exhibited in FIGS. 9A and 9B are merely illustrative and not intended to be limiting, unless mentioned otherwise. For example, optical transmittance profile 900T can represent an optical transmittance of optical filter 104, lens 200, lens 220, or lens 240 that includes a selective light wavelength filter and a chroma enhancement filter.

Optical transmittance profile 900T can include one or more transmittance valleys, such as valleys 904T and 906T, each having a minimum transmittance in one or more spectral bands. Such transmittance valleys (e.g., valleys 904T, 906T) can filter out or attenuate undesired spectral wavelengths of light. Accordingly, optical transmittance profile 900T can provide chroma enhancement and selective wavelength filtering in the one or more spectral bands. In some embodiments, optical transmittance profile 900T can also include one or more transmittance peaks such as peak 902T.

As discussed previously herein, each of the transmittance valleys in a spectrum can be regarded as an absorbance peak in the spectrum. For example, valleys 904T, 906T illustrated in optical transmittance profile 900T can be hereinafter represented as absorbance peaks 904A, 906A in optical absorbance profile 900A. As such, in referring to FIG. 9B, optical absorbance profile 900A can include absorbance peaks 904A, 906A associated with valleys 904T, 906T.

In some embodiments, the minimum transmittance of the transmittance valley 904T is positioned at a wavelength from about 450 nm to about 475 nm, from about 450 nm to about 470 nm, from about 455 nm to about 470 nm, from about 455 nm to about 465 nm, at about 459 nm, at about 460 nm, or at about 461 nm.

In some embodiments, a minimum transmittance of the first valley 904T is from about 15% to about 40%, from about 20% to about 35%, from about 20% to about 30%, or about 25% to about 30%.

In some embodiments, absorbance peak 904A can have a maximum optical density from about 0.4 to about 0.8, about 0.4 to about 0.7, from about 0.45 to about 0.65, from about 0.50 to about 0.65, or from about 0.55 to about 0.65.

Each transmittance valley in optical transmittance profile 900T can have a respective transmittance bandwidth defined as a full width of the each transmittance valley at certain offset from the minimum transmittance of the each transmittance valley, such as the minimum transmittance plus 1%, the minimum transmittance plus 5%, the minimum transmittance plus 10%, the minimum transmittance plus 15%, or the minimum transmittance plus 30%. In some embodiments, transmittance valley 904T can have a transmittance bandwidth of less than about 3 nm, less than about 5 nm, less than about 10 nm, less than about 15 nm, or less than about 20 nm at minimum transmittance plus 1%, the minimum transmittance plus 5%, the minimum transmittance plus 10%, the minimum transmittance plus 15%, or the minimum transmittance plus 30%, respectively.

In some embodiments, transmittance valley 904T can have a transmittance bandwidth at the minimum transmittance plus 30% from about 10 nm to about 20 nm, from about 12 nm to about 17 nm, or about 15 nm.

In some embodiments, transmittance valley 906T can have a transmittance bandwidth of less than about 50 nm, less than about 40 nm, less than about 30 nm, less than about 20 nm, less than about 15 nm, or less than about 10 nm at the minimum transmittance plus 5%.

In some embodiments, the maximum transmittance of the transmittance peak 902T is greater than or equal to about 60%, is greater than or equal to about 65%, is greater than or equal to about 70%, or is greater than or equal to about 75%.

In some embodiments, the maximum transmittance of peak 902T is at a wavelength from about 410 nm to about 450 nm, from about 420 nm to about 440 nm, or from about 420 nm to about 430 nm.

In some embodiments, a minimum transmittance of the second valley 906T is from about 70% to about 85%, from about from about 72% to about 80%, or from about 75% to about 80%.

In some embodiments, the minimum transmittance of second valley 906T is at a wavelength from about 570 nm to about 590 nm, from about 575 nm to about 585 nm, or from about 575 nm to about 580 nm.

In some embodiments, an E313 yellowness index of the optical filter 104, lens 200, lens 220, or lens 240 is from about 15 to about 35, is from about 20 to about 35, or is from about 20 to about 30.

In some embodiments, the optical filter 104, lens 200, lens 220, or lens 240 has an UV transmission cutoff at a wavelength from about 380 nm to about 400 nm, or about 400 nm.

In some embodiments, the average transmittance in a spectral range of about 425 nm to about 450 nm is greater than about 65%, is greater than about 70%, or is greater than about 75%.

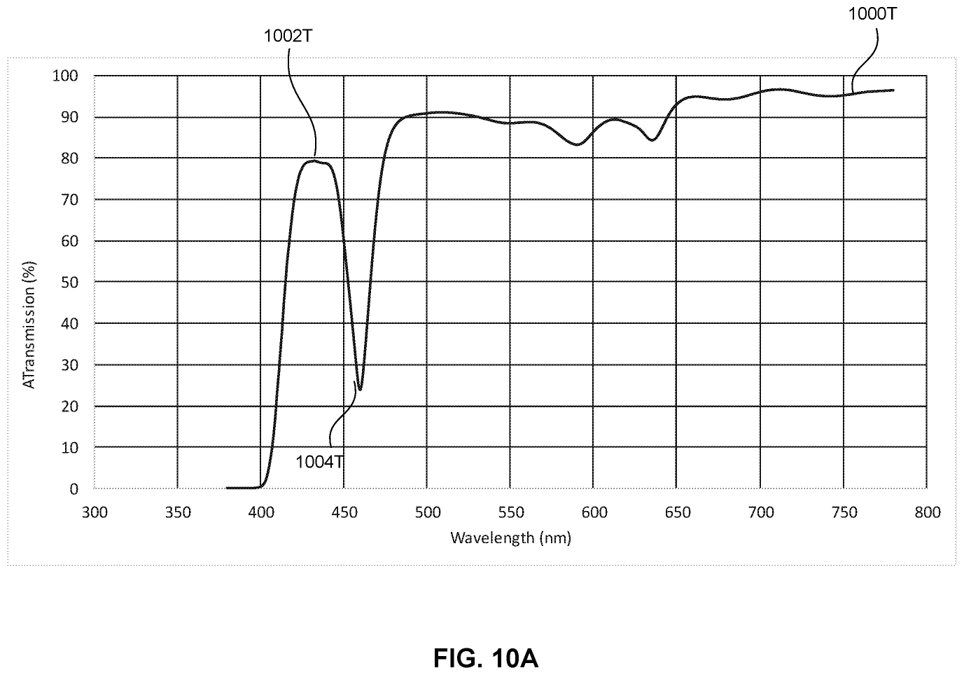

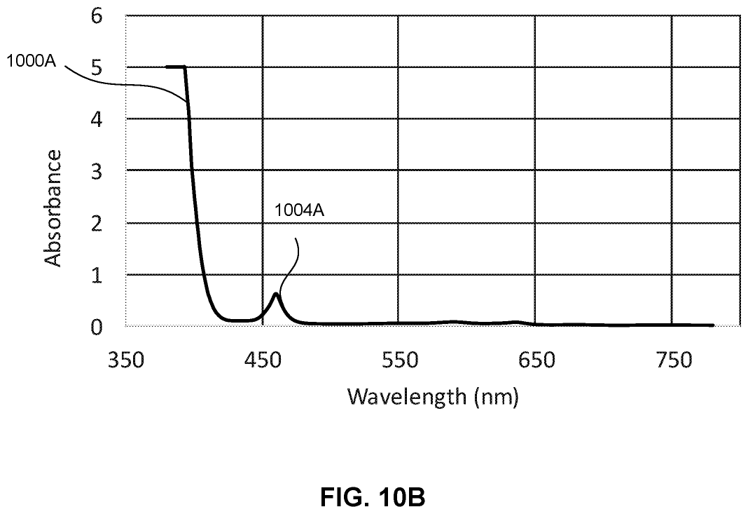

FIG. 10A illustrates an optical transmittance profile 1000T, according to some embodiments. FIG. 10B illustrates a respective optical absorbance profile 1000A, according to some embodiments. It would be understood that optical characteristics exhibited in FIGS. 10A and 10B are merely illustrative and not intended to be limiting, unless mentioned otherwise. For example, optical transmittance profile 1000T can represent an optical transmittance of optical filter 104, lens 200, lens 220, or lens 240 that includes a selective light wavelength filter.

Optical transmittance profile 1000T can include one or more transmittance valleys, such as valley 1004T having a minimum transmittance in one or more spectral bands, and one or more transmittance peaks such as peak 1002T, Such transmittance valleys (e.g., valley 1004T) can filter out or attenuate undesired spectral wavelengths of light. Accordingly, optical transmittance profile 1000T can provide selective filtering in the one or more spectral bands. As discussed previously herein, each of the transmittance valleys in a spectrum can be regarded as an absorbance peak in the spectrum. For example, valley 1004T illustrated in optical transmittance profile 1000T can be hereinafter represented as absorbance peak 1004A in optical absorbance profile 1000A. As such, in referring to FIG. 10B, optical absorbance profile 1000A can include an absorbance peak 1004A associated with valley 1004T.

In some embodiments, the minimum transmittance of the transmittance valley 1004T is positioned at a wavelength from about 450 nm to about 475 nm, from about 450 nm to about 470 nm, from about 455 nm to about 470 nm, from about 455 nm to about 465 nm, at about 459 nm, at about 460 nm, or at about 461 nm.

In some embodiments, a minimum transmittance of the first valley 1004T is from about 15% to about 40%, from about 20% to about 35%, or from about 20% to about 30%, or from about 22% to about 26%.

In some embodiments, absorbance peak 1004A can have a maximum optical density from about 0.4 to about 0.8, about 0.4 to about 0.7, from about 0.45 to about 0.65, from about 0.50 to about 0.65, or from about 0.55 to about 0.65.

Each transmittance valley in optical transmittance profile 1000T can have a respective transmittance bandwidth defined as a full width of the each transmittance valley at certain offset from the minimum transmittance of the each transmittance valley, such as the minimum transmittance plus 1%, the minimum transmittance plus 5%, the minimum transmittance plus 10%, the minimum transmittance plus 15%, or the minimum transmittance plus 30%. In some embodiments, transmittance valley 1004T can have a transmittance bandwidth of less than about 3 nm, less than about 5 nm, less than about 10 nm, less than about 15 nm, or less than about 20 nm at minimum transmittance plus 1%, the minimum transmittance plus 5%, the minimum transmittance plus 10%, the minimum transmittance plus 15%, or the minimum transmittance plus 30%, respectively.

In some embodiments, transmittance valley 1004T can have a transmittance bandwidth at the minimum transmittance plus 30% from about 10 nm to about 20 nm, from about 12 nm to about 17 nm, or about 15 nm.

In some embodiments, the maximum transmittance of the transmittance peak 1002T is greater than or equal to about 60%, is greater than or equal to about 65%, is greater than or equal to about 70%, or is greater than or equal to about 75%.

In some embodiments, the maximum transmittance of transmittance peak 1002T is at a wavelength from about 410 nm to about 450 nm, from about 420 nm to about 440 nm, or from about 420 nm to about 430 nm.

In some embodiments, an E313 yellowness index of the optical filter 104, lens 200, lens 220, or lens 240 is from about 15 to about 35, is from about 20 to about 35, or is from about 20 to about 30.

In some embodiments, the optical filter 104, lens 200, lens 220, or lens 240 has an UV transmission cutoff at a wavelength from about 380 nm to about 400 nm or about 400 nm.

In some embodiments, the average transmittance in a spectral range of about 425 nm to about 450 nm is greater than about 65%, is greater than about 70%, or is greater than about 75%.

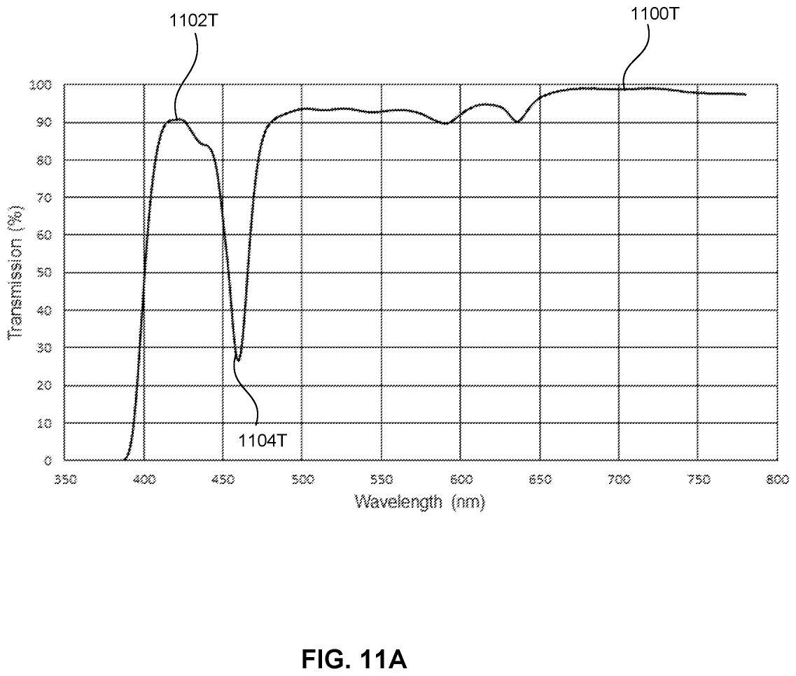

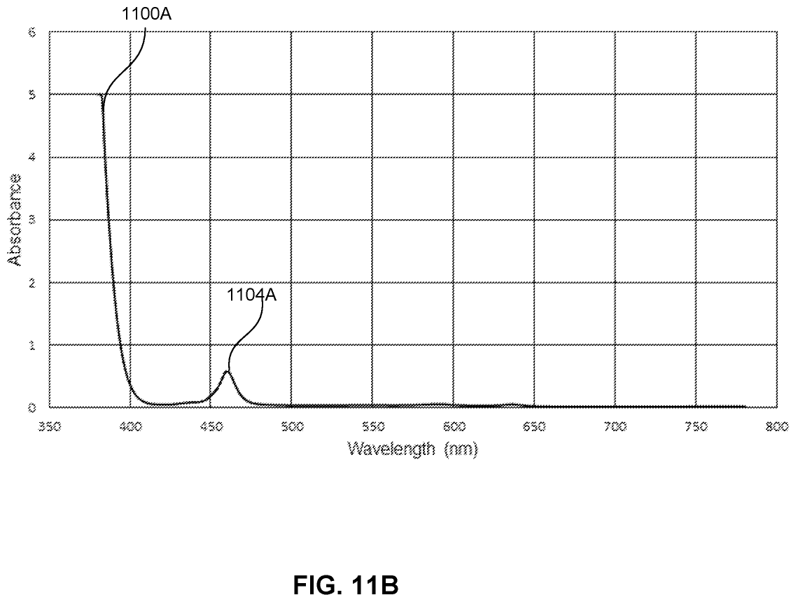

FIG. 11A illustrates an optical transmittance profile 1100T, according to some embodiments. FIG. 11B illustrates a respective optical absorbance profile 1100A, according to some embodiments. It would be understood that optical characteristics exhibited in FIGS. 11A and 11B are merely illustrative and not intended to be limiting, unless mentioned otherwise. For example, optical transmittance profile 1100T can represent an optical transmittance of optical filter 104, lens 200, lens 220, lens 240, or lens 260 that includes a selective light wavelength filter.

Optical transmittance profile 1100T can include one or more transmittance valleys, such as valley 1104T having a minimum transmittance in one or more spectral bands, and one or more transmittance peaks such as peak 1102T. Such transmittance valleys (e.g., valley 1104T) can filter out or attenuate undesired spectral wavelengths of light. Accordingly, optical transmittance profile 1100T can provide selective filtering in the one or more spectral bands. As discussed previously herein, each of the transmittance valleys in a spectrum can be regarded as an absorbance peak in the spectrum. For example, valley 1104T illustrated in optical transmittance profile 1100T can be hereinafter represented as absorbance peak 1104A in optical absorbance profile 1100A. As such, in referring to FIG. 11B, optical absorbance profile 1100A can include an absorbance peak 1104A associated with valley 1104T.

In some embodiments, the minimum transmittance of the transmittance valley 1104T is positioned at a wavelength from about 450 nm to about 475 nm, from about 450 nm to about 470 nm, from about 455 nm to about 470 nm, from about 455 nm to about 465 nm, at about 459 nm, at about 460 nm, or at about 461 nm.

In some embodiments, a minimum transmittance of the first valley 1104T is from about 15% to about 40%, from about 20% to about 35%, or from about 24% to about 28%.

In some embodiments, absorbance peak 1104A can have a maximum optical density from about 0.4 to about 0.8, from about 0.4 to about 0.7, from about 0.5 to about 0.65, or from about 0.55 to about 0.6.

Each transmittance valley in optical transmittance profile 1100T can have a respective transmittance bandwidth defined as a full width of the each transmittance valley at a certain offset from the minimum transmittance of the each transmittance valley, such as the minimum transmittance plus 1%, the minimum transmittance plus 5%, the minimum transmittance plus 10%, the minimum transmittance plus 15%, or the minimum transmittance plus 30%. In some embodiments, transmittance valley 1104T can have a transmittance bandwidth of less than about 3 nm, less than about 5 nm, less than about 10 nm, less than about 15 nm, or less than about 20 nm at minimum transmittance plus 1%, the minimum transmittance plus 5%, the minimum transmittance plus 10%, the minimum transmittance plus 15%, or the minimum transmittance plus 30%, respectively.

In some embodiments, transmittance valley 1104T can have a transmittance bandwidth at the minimum transmittance plus 30% from about 10 nm to about 20 nm, from about 12 nm to about 17 nm, about 16 nm, about 15 nm, or about 14 nm.

In some embodiments, the maximum transmittance of the transmittance peak 1102T is greater than or equal to about 60%, is greater than or equal to about 70%, is greater than or equal to about 80%, is greater than or equal to about 85%, or is greater than or equal to about 90%.

In some embodiments, the maximum transmittance of transmittance peak 1102T is at a wavelength from about 410 nm to about 450 nm, from about 410 nm to about 440 nm, or from about 415 nm to about 425 nm.

In some embodiments, an E313 yellowness index of optical filter 104, lens 200, lens 220, lens 240, or lens 260 is from about 15 to about 35, is from about 20 to about 30, or is from about 20 to 25.

In some embodiments, optical filter 104, lens 200, lens 220, lens 240, or lens 260 has an UV transmission cutoff at a wavelength from about 380 nm to about 400 nm or about 380 nm.

In some embodiments, the average transmittance in a spectral range of about 425 nm to about 450 nm is greater than about 65%, is greater than about 68%, is greater than about 70%, is greater than about 75%, or is greater than about 80%.

In some embodiments, a blue light transmittance of optical filter 104, lens 200, lens 220, lens 240, or lens 260 is less than about 85%, is less than about 80%, or is less than about 75%.

As discussed previously herein, various implementations of optical filter 104, lens 200, lens 220, lens 240, or lens 260 can be configured to switch between a light state and a dark state in response to an optical stimulus. At least one of a luminous transmittance or selective wavelength filtering can be different between the two states. For example, the absorbance spectrum of visible light transmitted through the optical filter can be different between the two states. The optical filter 104, lens 200, lens 220, lens 240, or lens 260 can provide filtering at more wavelengths when in the dark state compared to the light state.

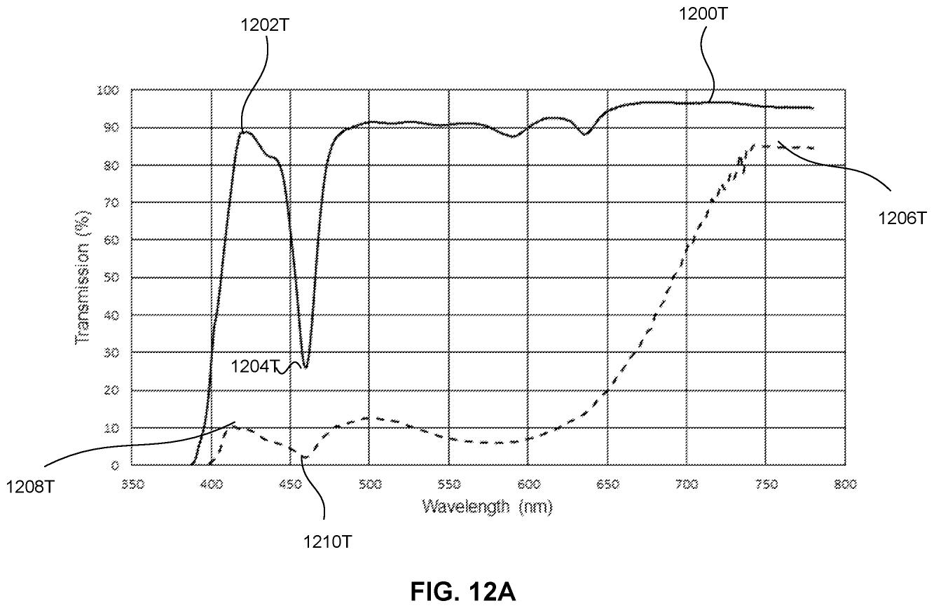

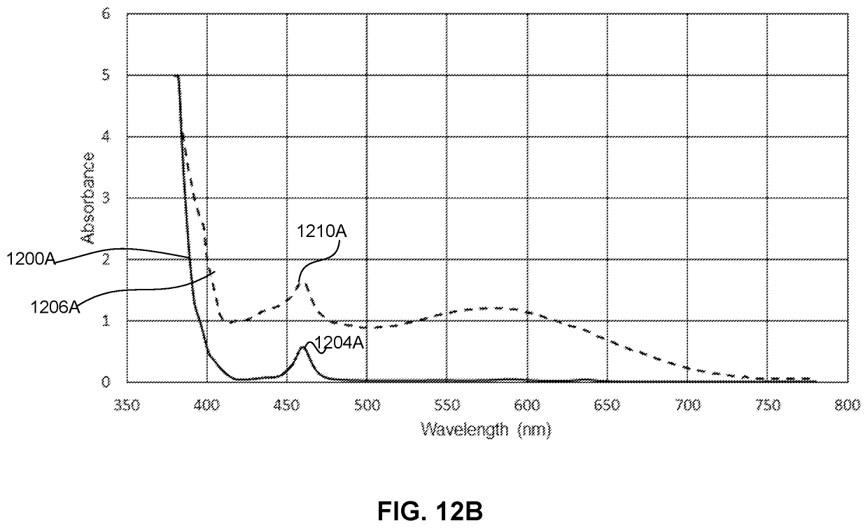

FIG. 12A illustrates an optical transmittance profile 1200T and an optical transmittance profile 1206T, according to some embodiments. FIG. 12B illustrates a respective optical absorbance profile 1200A and optical absorbance profile 1206A, according to some embodiments. It would be understood that optical characteristics exhibited in FIGS. 12A and 12B are merely illustrative and not intended to be limiting, unless mentioned otherwise. For example, optical transmittance profile 1200T can represent an optical transmittance of optical filter 104, lens 200, lens 220, lens 240, or lens 260 when in a light state. Optical transmittance profile 1206T can represent an optical transmittance of optical filter 104, lens 200, lens 220, lens 240, or lens 260 when in the dark state.

Optical transmittance profile 1200T can include one or more transmittance valleys, such as valley 1204T having a minimum transmittance in one or more spectral bands, and one or more transmittance peaks such as peak 1202T. Such transmittance valleys (e.g., valley 1204T) can filter out or attenuate undesired spectral wavelengths of light. Accordingly, optical transmittance profile 1200T can provide selective filtering in the one or more spectral bands. As discussed previously herein, each of the transmittance valleys in a spectrum can be regarded as an absorbance peak in the spectrum. For example, valley 1204T illustrated in optical transmittance profile 1200T can be hereinafter represented as absorbance peak 1204A in optical absorbance profile 1200A. As such, in referring to FIG. 12B, optical absorbance profile 1200A can include an absorbance peak 1204A associated with valley 1204T.

In some embodiments, the minimum transmittance of the transmittance valley 1204T is positioned at a wavelength from about 450 nm to about 475 nm, from about 450 nm to about 470 nm, from about 455 nm to about 470 nm, from about 455 nm to about 465 nm, at about 459 nm, at about 460 nm, or at about 461 nm.

In some embodiments, a minimum transmittance of the first valley 1204T is from about 15% to about 40%, from about 20% to about 35%, or from about 24% to about 28%.

In some embodiments, absorbance peak 1204A can have a maximum optical density from about 0.4 to about 0.8, from about 0.4 to about 0.7, from about 0.5 to about 0.65, or from about 0.55 to about 0.6.

Each transmittance valley in optical transmittance profile 1200T can have a respective transmittance bandwidth defined as a full width of the each transmittance valley at a certain offset from the minimum transmittance of the each transmittance valley, such as the minimum transmittance plus 1%, the minimum transmittance plus 5%, the minimum transmittance plus 10%, the minimum transmittance plus 15%, or the minimum transmittance plus 30%. In some embodiments, transmittance valley 1204T can have a transmittance bandwidth of less than about 3 nm, less than about 5 nm, less than about 10 nm, less than about 15 nm, or less than about 20 nm at minimum transmittance plus 1%, the minimum transmittance plus 5%, the minimum transmittance plus 10%, the minimum transmittance plus 15%, or the minimum transmittance plus 30%, respectively.

In some embodiments, transmittance valley 1204T can have a transmittance bandwidth at the minimum transmittance plus 30% from about 10 nm to about 20 nm, from about 12 nm to about 17 nm, about 16 nm, about 15 nm, or about 14 nm.

In some embodiments, the maximum transmittance of the transmittance peak 1202T is greater than or equal to about 60%, is greater than or equal to about 70%, is greater than or equal to about 80%, or is greater than or equal to about 85%.

In some embodiments, the maximum transmittance of transmittance peak 1202T is at a wavelength from about 410 nm to about 450 nm, from about 410 nm to about 440 nm, or from about 415 nm to about 425 nm.

In some embodiments, an E313 yellowness index of optical filter 104, lens 200, lens 220, lens 240, or lens 260 is from about 15 to about 35, is from about 20 to about 30, or is from about 20 to about 25 when in a light state.

In some embodiments, optical filter 104, lens 200, lens 220, lens 240, or lens 260 has an UV transmission cutoff at a wavelength from about 380 nm to about 400 nm or about 380 nm.

In some embodiments, the average transmittance in a spectral range of about 425 nm to about 450 nm is greater than about 65%, is greater than about 68%, is greater than about 70%, is greater than about 75%, or is greater than about 80%.

Optical transmittance profile 1206T can include one or more transmittance valleys, such as valley 1210T having a minimum transmittance in one or more spectral bands, and one or more transmittance peaks such as peak 1208T. Such transmittance valleys (e.g., valley 1210T) can filter out or attenuate undesired spectral wavelengths of light. Accordingly, optical transmittance profile 1206T can provide selective filtering in the one or more spectral bands. In some aspects, optical transmittance profile 1206T can provide selective filtering at the same and/or different wavelengths compared to optical transmittance profile 1200T. For example, optical transmittance profile 1206T can provide selective filtering at one or more spectral bands in addition to the one or more spectral bands of the optical transmittance profile 1200T. In some aspects, optical transmittance profile 1206T can provide selective filtering for a broader spectral band compared to 1200T (e.g., in a range from about 400 nm to about 500 nm).

As discussed previously herein, each of the transmittance valleys in a spectrum can be regarded as an absorbance peak in the spectrum. For example, valley 1210T illustrated in optical transmittance profile 1206T can be hereinafter represented as absorbance peak 1210A in optical absorbance profile 1206A. As such, in referring to FIG. 12B, optical absorbance profile 1206A can include an absorbance peak 1210A associated with valley 1210T.

In some embodiments, the minimum transmittance of the transmittance valley 1210T is positioned at a wavelength from about 450 nm to about 475 nm, from about 450 nm to about 470 nm, from about 455 nm to about 470 nm, from about 455 nm to about 465 nm, at about 459 nm, at about 460 nm, or at about 461 nm.

In some embodiments, a minimum transmittance of the first valley 1210T is from about 0% to about 10%, from about 1% to about 7%, or from about 2% to about 5%.

In some embodiments, absorbance peak 1210A can have a maximum optical density from about 1 to about 2.2, from about 1.2 to about 2, from about 1.4 to about 1.8, or from about 1.5 to about 1.7.

Each transmittance valley in optical transmittance profile 1206T can have a respective transmittance bandwidth defined as a full width of the each transmittance valley at a certain offset from the minimum transmittance of the each transmittance valley, such as the minimum transmittance plus 1% or the minimum transmittance plus 5%. In some embodiments, transmittance valley 1210T can have a transmittance bandwidth from about 3 nm to about 15 nm from about 3 nm to about 10 nm, or from about 30 nm to about 40 nm at minimum transmittance plus 1% or the minimum transmittance plus 5%, respectively.

In some embodiments, the maximum transmittance of the transmittance peak 1208T is greater than or equal to about 5%, is greater than or equal to about 7%, or is greater than or equal to about 10%.

In some embodiments, the maximum transmittance of transmittance peak 1208T is at a wavelength from about 400 nm to about 450 nm, from about 405 nm to about 425 nm, or from about 410 nm to about 420 nm.

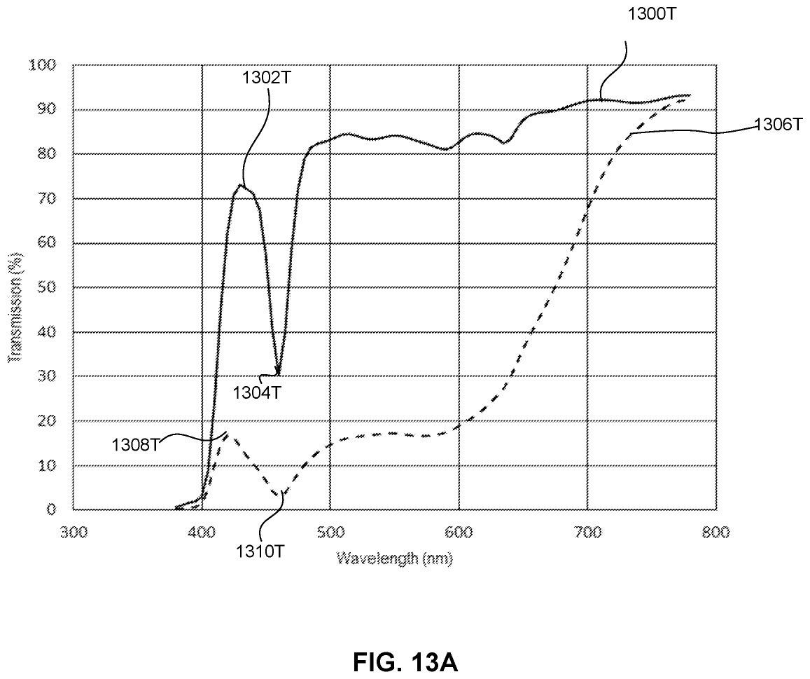

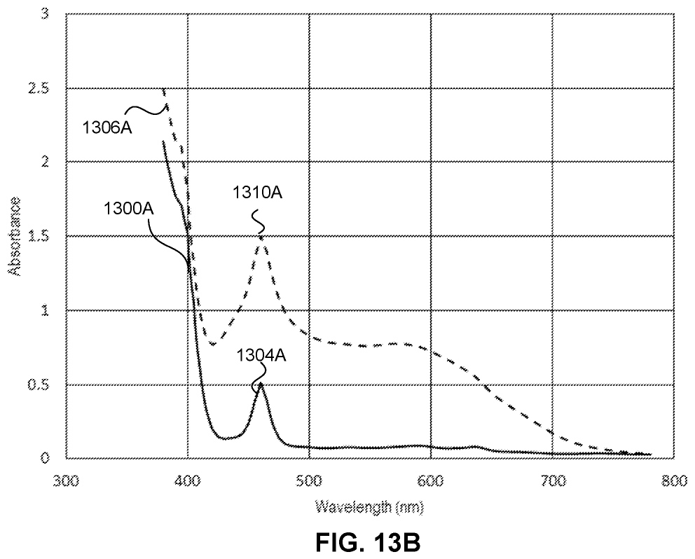

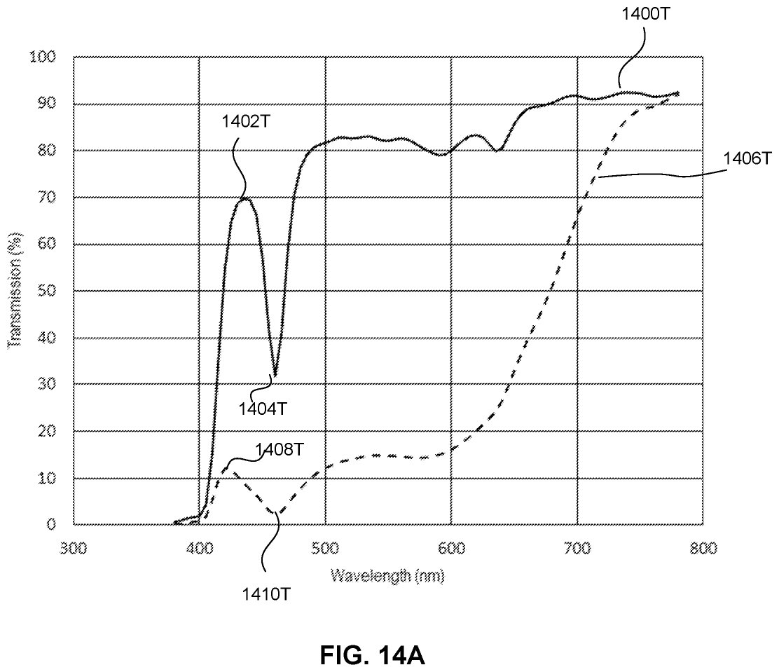

FIG. 13A illustrates an optical transmittance profile 1300T and an optical transmittance profile 1306T, according to some embodiments. FIG. 13B illustrates a respective optical absorbance profile 1300A and optical absorbance profile 1306A, according to some embodiments. It would be understood that optical characteristics exhibited in FIGS. 13A and 13B are merely illustrative and not intended to be limiting, unless mentioned otherwise. For example, optical transmittance profile 1300T can represent an optical transmittance of optical filter 104, lens 200, lens 220, lens 240, or lens 260 when in the light state. Optical transmittance profile 1306T can represent an optical transmittance of optical filter 104, lens 200, lens 220, lens 240, or lens 260 when in the dark state.

Optical transmittance profile 1300T can include one or more transmittance valleys, such as valley 1304T having a minimum transmittance in one or more spectral bands, and one or more transmittance peaks such as peak 1302T. Such transmittance valleys (e.g., valley 1304T) can filter out or attenuate undesired spectral wavelengths of light. Accordingly, optical transmittance profile 1300T can provide selective filtering in the one or more spectral bands. As discussed previously herein, each of the transmittance valleys in a spectrum can be regarded as an absorbance peak in the spectrum. For example, valley 1304T illustrated in optical transmittance profile 1300T can be hereinafter represented as absorbance peak 1304A in optical absorbance profile 1300A. As such, in referring to FIG. 13B, optical absorbance profile 1300A can include an absorbance peak 1304A associated with valley 1304T.

In some embodiments, the minimum transmittance of the transmittance valley 1304T is positioned at a wavelength from about 450 nm to about 475 nm, from about 450 nm to about 470 nm, from about 455 nm to about 470 nm, from about 455 nm to about 465 nm, at about 459 nm, at about 460 nm, or at about 461 nm.

In some embodiments, a minimum transmittance of the first valley 1304T is from about 20% to about 40%, from about 25% to about 35%, or from about 28% to about 32%.

In some embodiments, absorbance peak 1304A can have a maximum optical density from about 0.4 to about 0.6, from about 0.45 to about 0.55, or from about 0.48 to about 0.54.

Each transmittance valley in optical transmittance profile 1300T can have a respective transmittance bandwidth defined as a full width of the each transmittance valley at certain offset from the minimum transmittance of the each transmittance valley, such as the minimum transmittance plus 1%, the minimum transmittance plus 5%, the minimum transmittance plus 10%, the minimum transmittance plus 15%, or the minimum transmittance plus 30%. In some embodiments, transmittance valley 1304T can have a transmittance bandwidth of less than about 3 nm, less than about 6 nm, less than about 10 nm, less than about 15 nm, or less than about 25 nm at minimum transmittance plus 1%, the minimum transmittance plus 5%, the minimum transmittance plus 10%, the minimum transmittance plus 15%, or the minimum transmittance plus 30%, respectively.

In some embodiments, transmittance valley 1304T can have a transmittance bandwidth at the minimum transmittance plus 30% from about 10 nm to about 30 nm, from about 15 nm to about 25 nm, about 20 nm, about 21 nm, 22 nm, 23 nm, or about 24 nm.

In some embodiments, the maximum transmittance of the transmittance peak 1302T is greater than or equal to about 60%, is greater than or equal to about 65%, or is greater than or equal to about 70%.

In some embodiments, the maximum transmittance of transmittance peak 1302T is at a wavelength from about 410 nm to about 450 nm, from about 420 nm to about 440 nm, or from about 425 nm to about 435 nm.

In some embodiments, an E313 yellowness index of optical filter 104, lens 200, lens 220, lens 240, or lens 260 is from about 15 to about 35, is from about 20 to about 30, or is from about 20 to about 25 when in a light state.

In some embodiments, optical filter 104, lens 200, lens 220, lens 240, or lens 260 has an UV transmission cutoff at a wavelength from about 380 nm to about 400 nm or about 380 nm.

In some embodiments, the average transmittance in a spectral range of about 425 nm to about 450 nm is greater than about 60%, is greater than about 65%, or is greater than about 68%.

Optical transmittance profile 1306T can include one or more transmittance valleys, such as valley 1310T having a minimum transmittance in one or more spectral bands, and one or more transmittance peaks such as peak 1308T. Such transmittance valleys (e.g., valley 1310T) can filter out or attenuate undesired spectral wavelengths of light. Accordingly, optical transmittance profile 1306T can provide selective filtering in the one or more spectral bands. In some aspects, optical transmittance profile 1306T can provide selective filtering at the same and/or different wavelengths compared to optical transmittance profile 1300T. For example, optical transmittance profile 1306T can provide selective filtering at one or more spectral bands in addition to the one or more spectral bands of the optical transmittance profile 1300T. In some aspects, optical transmittance profile 1306T can provide selective filtering for a broader spectral band compared to 1300T.

As discussed previously herein, each of the transmittance valleys in a spectrum can be regarded as an absorbance peak in the spectrum. For example, valley 1310T illustrated in optical transmittance profile 1306T can be hereinafter represented as absorbance peak 1310A in optical absorbance profile 1306A. As such, in referring to FIG. 13B, optical absorbance profile 1306A can include an absorbance peak 1310A associated with valley 1310T.

In some embodiments, the minimum transmittance of the transmittance valley 1310T is positioned at a wavelength from about 450 nm to about 475 nm, from about 450 nm to about 470 nm, from about 455 nm to about 470 nm, from about 455 nm to about 465 nm, at about 459 nm, at about 460 nm, or at about 461 nm.

In some embodiments, a minimum transmittance of the first valley 1310T is from about 0% to about 10%, from about 1% to about 7%, or from about 2% to about 5%.

In some embodiments, absorbance peak 1310A can have a maximum optical density from about 1 to about 2.2, from about 1.2 to about 2, from about 1.4 to about 1.8, or from about 1.45 to about 1.7.

Each transmittance valley in optical transmittance profile 1306T can have a respective transmittance bandwidth defined as a full width of the each transmittance valley at a certain offset from the minimum transmittance of the each transmittance valley, such as the minimum transmittance plus 1% or the minimum transmittance plus 5%. In some embodiments, transmittance valley 1310T can have a transmittance bandwidth from about 7 nm to about 12 nm or from about 25 nm to about 35 nm at minimum transmittance plus 1% or the minimum transmittance plus 5%, respectively.

In some embodiments, the maximum transmittance of the transmittance peak 1308T is greater than or equal to about 5%, is greater than or equal to about 10%, or is greater than or equal to about 15%.

In some embodiments, the maximum transmittance of transmittance peak 1308T is at a wavelength from about 400 nm to about 450 nm, from about 405 nm to about 435 nm, or from about 415 nm to about 425 nm.

In some embodiments, a blue light transmittance of optical filter 104, lens 200, lens 220, lens 240, or lens 260 is less than about 85%, is less than about 75%, is less than about 70%, is less than about 65%, or is from about 57% to about 63% when in the light state.

In some embodiments, a blue light transmittance of optical filter 104, lens 200, lens 220, lens 240, or lens 260 is from about 1% to about 20%, from about 5% to about 15%, is less than 15%, about 9%, about 10%, or about 11% when in the dark state.

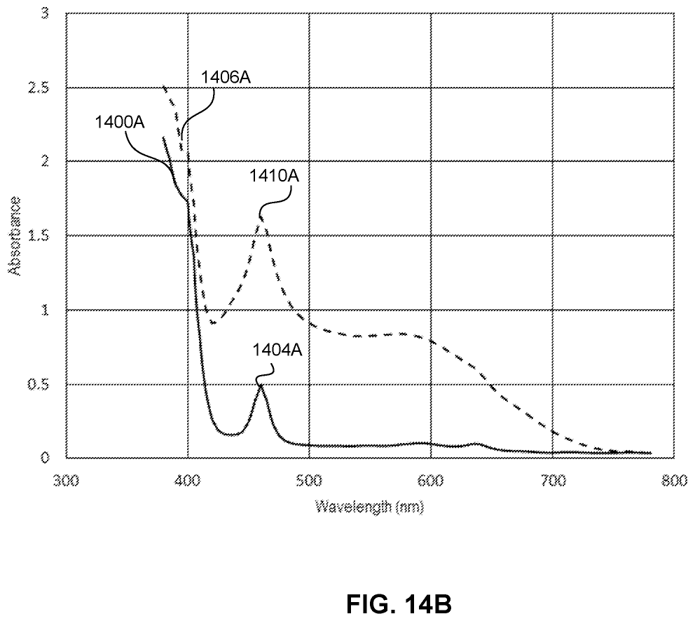

FIG. 14A illustrates an optical transmittance profile 1400T and an optical transmittance profile 1406T, according to some embodiments. FIG. 14B illustrates a respective optical absorbance profile 1400A and optical absorbance profile 1406A, according to some embodiments. It would be understood that optical characteristics exhibited in FIGS. 14A and 14B are merely illustrative and not intended to be limiting, unless mentioned otherwise. For example, optical transmittance profile 1400T can represent an optical transmittance of optical filter 104, lens 200, lens 220, lens 240, or lens 260 when in the light state. Optical transmittance profile 1406T can represent an optical transmittance of optical filter 104, lens 200, lens 220, lens 240, or lens 260 when in the dark state.

Optical transmittance profile 1400T can include one or more transmittance valleys, such as valley 1404T having a minimum transmittance in one or more spectral bands, and one or more transmittance peaks such as peak 1402T. Such transmittance valleys (e.g., valley 1404T) can filter out or attenuate undesired spectral wavelengths of light. Accordingly, optical transmittance profile 1400T can provide selective filtering in the one or more spectral bands. As discussed previously herein, each of the transmittance valleys in a spectrum can be regarded as an absorbance peak in the spectrum. For example, valley 1404T illustrated in optical transmittance profile 1400T can be hereinafter represented as absorbance peak 1404A in optical absorbance profile 1400A. As such, in referring to FIG. 14B, optical absorbance profile 1400A can include an absorbance peak 1404A associated with valley 1404T.

In some embodiments, the minimum transmittance of the transmittance valley 1404T is positioned at a wavelength from about 450 nm to about 475 nm, from about 450 nm to about 470 nm, from about 455 nm to about 470 nm, from about 455 nm to about 465 nm, at about 459 nm, at about 460 nm, or at about 461 nm.

In some embodiments, a minimum transmittance of the first valley 1404T is from about 20% to about 40%, from about 25% to about 35%, or from about 28% to about 33%.

In some embodiments, absorbance peak 1404A can have a maximum optical density from about 0.4 to about 0.6, from about 0.45 to about 0.55, or from about 0.48 to about 0.52.

Each transmittance valley in optical transmittance profile 1400T can have a respective transmittance bandwidth defined as a full width of the each transmittance valley at a certain offset from the minimum transmittance of the each transmittance valley, such as the minimum transmittance plus 1%, the minimum transmittance plus 5%, the minimum transmittance plus 10%, the minimum transmittance plus 15%, or the minimum transmittance plus 30%. In some embodiments, transmittance valley 1404T can have a transmittance bandwidth of less than about 3 nm, less than about 6 nm, less than about 10 nm, less than about 15 nm, or less than about 25 nm at minimum transmittance plus 1%, the minimum transmittance plus 5%, the minimum transmittance plus 10%, the minimum transmittance plus 15%, or the minimum transmittance plus 30%, respectively.

In some embodiments, transmittance valley 1404T can have a transmittance bandwidth at the minimum transmittance plus 30% from about 10 nm to about 30 nm, from about 15 nm to about 25 nm, about 20 nm, about 21 nm, 22 nm, 23 nm, or about 24 nm.

In some embodiments, the maximum transmittance of the transmittance peak 1402T is greater than or equal to about 60% or is greater than or equal to about 65%.

In some embodiments, the maximum transmittance of transmittance peak 1402T is at a wavelength from about 410 nm to about 450 nm, from about 425 nm to about 445 nm, or from about 430 nm to about 440 nm.

In some embodiments, an E313 yellowness index of optical filter 104, lens 200, lens 220, lens 240, or lens 260 is from about 15 to about 35, is from about 20 to about 30, or is from about 20 to about 25 when in the light state.

In some embodiments, optical filter 104, lens 200, lens 220, lens 240, or lens 260 has an UV transmission cutoff at a wavelength from about 380 nm to about 400 nm or about 380 nm.

In some embodiments, the average transmittance in a spectral range of about 425 nm to about 450 nm is greater than about 60%, or is greater than about 65%.

Optical transmittance profile 1406T can include one or more transmittance valleys, such as valley 1410T having a minimum transmittance in one or more spectral bands, and one or more transmittance peaks such as peak 1408T. Such transmittance valleys (e.g., valley 1410T) can filter out or attenuate undesired spectral wavelengths of light. Accordingly, optical transmittance profile 1406T can provide selective filtering in the one or more spectral bands. In some aspects, optical transmittance profile 1406T can provide selective filtering at the same and/or different wavelengths compared to optical transmittance profile 1400T. For example, optical transmittance profile 1406T can provide selective filtering at one or more spectral bands in addition to the one or more spectral bands of the optical transmittance profile 1400T. In some aspects, optical transmittance profile 1406T can provide selective filtering for a broader spectral band compared to optical transmittance profile 1400T.

As discussed previously herein, each of the transmittance valleys in a spectrum can be regarded as an absorbance peak in the spectrum. For example, valley 1410T illustrated in optical transmittance profile 1406T can be hereinafter represented as absorbance peak 1410A in optical absorbance profile 1406A. As such, in referring to FIG. 14B, optical absorbance profile 1406A can include an absorbance peak 1410A associated with valley 1410T.

In some embodiments, the minimum transmittance of the transmittance valley 1410T is positioned at a wavelength from about 450 nm to about 475 nm, from about 450 nm to about 470 nm, from about 455 nm to about 470 nm, from about 455 nm to about 465 nm, at about 459 nm, at about 460 nm, or at about 461 nm.

In some embodiments, a minimum transmittance of the first valley 1410T is from about 0% to about 10%, from about 1% to about 7%, or from about 1% to about 4%.

In some embodiments, absorbance peak 1410A can have a maximum optical density from about 1 to about 2.2, from about 1.2 to about 2, from about 1.4 to about 1.8, or from about 1.5 to about 1.7.

Each transmittance valley in optical transmittance profile 1406T can have a respective transmittance bandwidth defined as a full width of the each transmittance valley at certain offset from the minimum transmittance of the each transmittance valley, such as the minimum transmittance plus 1% or the minimum transmittance plus 5%. In some embodiments, transmittance valley 1410T can have a transmittance bandwidth from about 8 nm to about 15 nm or from about 25 nm to about 45 nm at minimum transmittance plus 1% or the minimum transmittance plus 5%, respectively.

In some embodiments, the maximum transmittance of the transmittance peak 1408T is greater than or equal to about 5%, is greater than or equal to about 10%, or is from about 5% to about 20%.

In some embodiments, the maximum transmittance of transmittance peak 1408T is at a wavelength from about 400 nm to about 450 nm, from about 405 nm to about 435 nm, or from about 415 nm to about 425 nm.

In some embodiments, a blue light transmittance of optical filter 104, lens 200, lens 220, lens 240, or lens 260 is less than about 50%, is greater than about 55%, is from about 55% to about 65%, is from about 57% to about 63%, or is less than about 70% when in the light state.

In some embodiments, a blue light transmittance of optical filter 104, lens 200, lens 220, lens 240, or lens 260 is from about 1% to about 20%, from about 5% to about 15%, is less than about 15%, is less than about 10%, about 6%, about 7%, or about 8% when in the dark state.

In some embodiments, a method for forming a filter configured to provide selective wavelength filtering for an eyewear is provided. This disclosure is not limited to this operational description. It is to be appreciated that additional operations may be performed. Moreover, not all operations may be needed to perform the disclosure provided herein. Further, some of the operations may be performed simultaneously, or in a different order than described. In some implementations, one or more other operations may be performed in addition to or in place of the presently described operations.

In some embodiments, a lens body with selective wavelength filtering is formed. In some embodiments, the process of forming the lens body can include providing an optically transparent material, and incorporating one or more wavelength filtering materials with the optically transparent material. Namely, the optically transparent material can be blended with the wavelength filtering materials to form the lens body. For example, one or more wavelength filtering dyes can be added to a molten resin before the resin is injected a mold cavity to form the lens body. By way of example and not limitation, the optically transparent material can include molten resin, polycarbonate (PC), allyl diglycol carbonate monomer (being sold under the brand name CR-39®), a resin layer (e.g., MR-8g), glass, nylon, polyurethane, polyethylene, polyureas, polyamide (PA), polyethylene terephthalate (PET), biaxially-oriented polyethylene terephthalate polyester film (BoPET, with one such polyester film sold under the brand name MYLAR®), acrylic (polymethyl methacrylate or PMMA), triacetate cellulose (TAC), a polymeric material, a co-polymer, a doped material, any other suitable material, or any combination thereof. By way of example and not limitation, the wavelength filtering materials and/or chroma enhancement material can include a dielectric stack, multilayer interference coatings, rare earth oxide additives, an organic dye, or a combination therefore. In some embodiments, the organic dye for the wavelength filtering material and chroma enhancement material can include ABS 454, ABS 454F, ABS 455, ABS 456, ABS 574, or ABS 584 dye supplied by Exciton of Dayton, Ohio. In some embodiments, the process of forming the lens body can include forming a lens substrate, and forming a wavelength selective filter layer over the lens substrate. By way of example and not limitation, a forming process of the lens substrate can include applying injection molding process, a thermoforming process, a casting process, or a machining process on the optically transparent material described above. By way of example and not limitation, the process of forming the wavelength selective filter layer over the lens body can include placing the wavelength filtering material over one or more surfaces of the lens substrate using a deposition process, a coating process, an inkjet-printing process, an epitaxial process, a plating process, a material growth process (e.g., self-assembly growth), or a laminating process. In some embodiments, the process of forming the lens body can include forming a wavelength selective filtering wafer, and forming a lens substrate over the a wavelength selective filtering wafer. By way of example and not limitation, the process of forming a wavelength selective filtering wafer can include injection molding or casting a wafer that includes one or more wavelength filtering materials. By way of example and not limitation, the process of forming the lens body over the wavelength selective filtering wafer can include placing the wavelength selective filtering wafer in a mold cavity and molding an optically transparent material, such as resin, over one or more surfaces of the wavelength filtering wafer in the mold cavity. As a result, after the optically transparent material (e.g., resin) is cooled down and hardened, the lens body can conform to the wavelength filtering wafer. It is noted that the above described embodiments for forming the lens body are exemplary and not limiting. Various implementations for forming the lens body are described, for example, in U.S. patent application Ser. No. 15/359,317, which is incorporated by reference herein and is made part of this disclosure.

In some embodiments, one or more functional layers can be formed over the lens body. By way of example and not limitation, each of the one or more functional layers can include a hard coat layer, an interference stack, a flash mirror, a photochromic layer, an electrochromic layer, an anti-static coating, a liquid containing layer, a trichoic filter, a glass layers, a hybrid glass-plastic layer, an index matching layers, or any combination of these. In some embodiments, the process of forming the one or more functional layers can include a laminating technique, a coating technique, a deposition technique, or any combination of these.

It would be understood that the above noted embodiments are merely illustrative and not limiting. Other examples of forming the lens body having selective wavelength filtering are disclosed in U.S. Pat. Pub. No. 2017/0075143, entitled “Eyewear and lenses with multiple molded lens components,” filed Nov. 22, 2016, and U.S. Pat. Pub. No. 2017/0102558, entitled “Eyewear with multiple functional layers,” filed Oct. 28, 2016, which are incorporated herein by reference.

In some embodiments, an optical reflectivity from the lens body is reduced. The reduction of the optical reflectivity can include forming an anti-reflection layer over the lens body's back surface and/or the lens body's front surface. In some embodiments, in response to the anti-reflection layer's refractive index being between air's refractive index (e.g., 1.0) and the lens body's refractive index, an optical reflectivity from the lens body's back surface can be reduced.

The foregoing disclosure outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A lens of an eyewear comprising an optical filter, wherein a transmittance spectral profile of the optical filter comprises a transmission valley having a minimum transmittance with a spectral bandwidth, wherein:
the minimum transmittance of the transmittance valley is positioned at a first wavelength from about 450 nm to about 475 nm; and
the spectral bandwidth, equal to the full width of the transmittance valley at the minimum transmittance plus 30%, is less than or equal to about 30 nm.

2. The lens of claim 1, wherein the minimum transmittance of the transmittance valley is from about 15% to about 40%.

3. The lens of claim 1, wherein the first wavelength is from about 455 nm to about 465 nm.

4. The lens of claim 3, wherein the first wavelength is about 460 nm.

5. The lens of claim 1, wherein the first wavelength is from about 450 nm to about 470 nm.

6. The lens of claim 1, wherein the transmittance spectral profile further comprises another transmittance valley, the other transmittance valley having a minimum transmittance positioned at a second wavelength from about 570 nm to about 590 nm, wherein the minimum transmittance of the other transmittance valley is from about 70% to about 85%.

7. The lens of claim 1, wherein the lens has an ultraviolet (UV) transmission cutoff at a third wavelength from about 380 nm to about 400 nm.

8. The lens of claim 1, wherein an E313 yellowness index of the lens is from about 15 to about 35.

9. The lens of claim 1, wherein a photopic transmission of the optical filter is from about 82% to about 95%.

10. The lens of claim 1, wherein a scotopic transmission of the optical filter is from about 77% to about 95%.

11. The lens of claim 1, wherein the optical filter further comprises an anti-reflection layer.

12. The lens of claim 1, wherein the optical filter comprises one or more organic dyes.

13. The lens of claim 1, wherein an average absorptance of the optical filter in a spectral range of about 380 nm to about 500 nm is from about 30% to about 50%.

14. The lens of claim 1, wherein an average transmittance of the optical filter in a spectral range of about 420 nm to about 440 nm is greater than about 70%.

15. The lens of claim 1, wherein the transmittance spectral profile of the optical filter further comprises a transmission peak having a maximum transmittance, wherein:
the maximum transmittance of the transmittance peak is positioned at a second wavelength from about 410 nm to about 450 nm; and
the maximum transmittance of the transmittance peak is greater than or equal to about 60%.

16. The lens of claim 15, wherein the maximum transmittance of the transmittance peak is greater than or equal to about 70%.

17. The lens of claim 15, wherein an average transmittance of the transmittance spectral profile in a spectral range of about 480 nm to about 560 nm is greater than or equal to about 80%.

18. An optical component comprising a lens, wherein:
an E313 yellowness index of the lens is less than about 35; and
a spectral transmittance profile of the lens comprises a first absorbance peak in a spectral range of about 450 nm to about 475 nm, wherein an optical density at a maximum absorbance of the first absorbance peak is from about 0.4 to about 0.8.

19. The optical component of claim 18, wherein the first absorbance peak is in the spectral range from about 455 nm to about 465 nm.

20. The optical component of claim 18, wherein the first absorbance peak is located at about 460 nm.

21. The optical component of claim 18, wherein the first absorbance peak is in the spectral range from about 450 nm to about 470 nm.

22. The optical component of claim 18, wherein an average absorptance of the lens in a spectral range of about 380 nm to about 500 nm is from about 25% to about 50%.

23.-31. (canceled)

32. A lens of an eyewear comprising an optical filter, wherein:
the optical filter is configured to switch between a light state and a dark state;
a transmittance spectral profile of the optical filter comprises a transmission valley having a minimum transmittance with a spectral bandwidth;
the minimum transmittance of the transmittance valley is positioned at a first wavelength from about 450 nm to about 475 nm; and
the spectral bandwidth, equal to the full width of the transmittance valley at the minimum transmittance plus 30%, is less than or equal to about 30 nm when in the light state.

33. The lens of claim 32, wherein the spectral bandwidth, equal to the full width of the transmittance valley at the minimum transmittance plus 5%, is from about 25 nm to about 45 nm when in the dark state.

34. The lens of claim 32, wherein the spectral bandwidth, equal to the full width of the transmittance valley at the minimum transmittance plus 1%, is from about 3 nm to about 15 nm when in the dark state.

35. The lens of claim 32, wherein the spectral bandwidth, equal to the full width of the transmittance valley at the minimum transmittance plus 1% is from about 7 nm to about 15 nm.

36. The lens of claim 32, wherein the spectral bandwidth, equal to the full width of the transmittance valley at the minimum transmittance plus 1% is from about 3 nm to about 10 nm.

37. The lens of claim 32, wherein a blue light transmittance of the lens is less than about 75% when in the light state and wherein the blue light transmittance of the lens is less than about 20% when in the dark state.

38. The lens of claim 32, wherein the minimum transmittance of the transmittance valley is from about 0% to about 10% when in the dark state.

39. The lens of claim 32, wherein the minimum transmittance of the transmittance valley is from about 2% to about 5% when in the dark state.

40. The lens of claim 32, wherein the first wavelength is from about 455 nm to about 465 nm.

41. The lens of claim 32, wherein the optical filter further comprises an anti-reflection layer.

42. The lens of claim 32, wherein the optical filter comprises one or more organic dyes.

43. The lens of claim 32, wherein an average transmittance of the optical filter in a spectral range of about 425 nm to about 450 nm is greater than about 60% when in the light state.

44. The lens of claim 32, wherein the transmittance spectral profile of the optical filter further comprises a transmission peak having a maximum transmittance, wherein:
the maximum transmittance of the transmittance peak is positioned at a second wavelength from about 400 nm to about 450 nm; and
the maximum transmittance of the transmittance peak is greater than or equal to about 60% when in the light state.

45. The lens of claim 32, wherein the maximum transmittance of the transmittance peak is from about 5% to about 20% when in the dark state.

46. The lens of claim 32, wherein the lens is a plano lens.

47. The lens of claim 32, wherein the lens is corrective lens.

48. An eyewear comprising the lens of claim 32.

49.-58. (canceled)

59. An eyewear comprising the lens of claim 1.

60. An eyewear comprising the optical component of claim 18.
